(19) United States
(12) Patent Application Publication
(10) Pub. No.: US 2024/0202617 A1
(43) Pub. Date: Jun. 20, 2024

(54) SYSTEM FOR SUPERVISION OF THE OPERATION AND MAINTENANCE OF INDUSTRIAL EQUIPMENT

(71) Applicant: SEADVANCE, Toulon (FR)

(72) Inventor: Fabrice Ravignon, Toulon (FR)

(21) Appl. No.: 18/288,160

(22) PCT Filed: Apr. 26, 2023
(86) PCT No.: PCT/EP22/60969

§ 371 Date: Oct. 24, 2023

(30) Foreign Application Priority Data
Apr. 28, 2021 (FR) 2104418

(51) Int. Cl. G06Q 10/0631

(52) U.S. Cl. CPC G06Q 10/06311

(57) ABSTRACT

The present invention relates to a system (1) for supervision of the operation and maintenance of an item of equipment (2) in a facility (3), in which the equipment (2) is operated up to maintenance (6) to be performed, with at least one subsequent projected maintenance (7), inducing a manufacturing and maintenance log (9), a usage log (11), a log (120) of statuses (13). A correlation (14) is determined between causes and consequences of aging of the equipment (2), by characterizing tasks (90) and conditions (110) impacting the status (13).

For other equipment, data corresponding to said correlation (14) is recovered and extracted, in order to train a virtual model (16).

The day before the maintenance (6) to be carried out, based on the logs (9, 11), tasks (90) of the maintenance (6) to be carried out and projected conditions (110) of a scenario (8), said model (16) generates a projected status (130) compared to a minimal operating status (17) for said equipment (2).

The present invention belongs to the field of supervision of industrial equipment with a view to managing its life cycle:
optimizing its manufacture, adapting its manufacture for a given usage profile;
optimizing and adapting its maintenance to an intended usage profile;
determining its maintenance thus optimized over the long term of its service life;
identifying usages compatible with an absence of failures during operation up to the next maintenance (zero failures);
identifying the usages compatible with zero failures over the long term of its service life;
instructing and optimizing the extension of its service life for an intended usage profile.

### TECHNICAL FIELD

The invention finds a preferred but non-limiting application in the supervision of medium- to high-stake industrial equipment and facilities, in the sense that the equipment in question is subject to reliability requirements, and all the more so when the reliability requirement is coupled with a safety requirement. This equipment includes especially:
equipment whose unavailability interrupts the production of a service or product of the overall facility to which this equipment belongs;
equipment whose unavailability induces or aggravates an incidental or accidental situation of the facility.

The invention thus finds non-limiting applications in the transport sector (road, air, sea, rail), but also in the sector of processing industries (utilities for “community services”, such as the production of electricity, water, fuel), or else in the defense sector.

In the context of the present invention, the generic term “equipment” thus encompasses a component of a facility, a component that is functional and essential for the correct operation and/or safety of this facility.

The equipment in question therefore consists of components of mobile facilities, such as machinery or vehicles (for example submersibles, ships, aircraft or spacecraft), or else components of stationary facilities, such as structures or infrastructures (for example, electric power plants, oil platforms or refineries).

Because the invention thus allows superior reliability guarantees in terms of manufacturing, maintenance and operation, the invention meets the high expectations of the industrial players involved in the value chain of this type of equipment, in particular designers, manufacturers, maintenance technicians and operators.

The reliability of the equipment in question is essential since its failure leads to the shutdown of production in the facility. The reliability of such equipment is all the more essential when its reliability is a safety requirement for the facility to which it belongs.

In this context, the invention makes the following choices: the reliability of the equipment depends on the quality of its manufacture, on its past maintenance and on its past usage, as well as on the future usage for which the equipment is intended.

The issues of equipment reliability thus indicate all the benefits of controlling how the design and manufacture, maintenance and usage of said equipment impact the reliability thereof.

It is therefore essential to answer the following questions:
which tasks (gestures, parts and settings) for manufacturing the equipment optimize the behavior of the equipment during operation, taking into account the intended usage thereof?
which tasks to be performed for maintenance of the equipment allow the optimum ratio between maintenance cost and the potential for the equipment to have zero failures up to the next maintenance (taking into account the future usage for which the equipment is intended and taking into account its own manufacturing, maintenance and usage log)?
what is the limit usage of the equipment to be observed up to the next maintenance, namely the maximum usage compatible with the zero failures up to the next maintenance?

It is also useful to determine at all times the optimal tasks for each of the maintenance operations in the rest of the service life of the equipment, as well as its residual service life (taking into account the future usage and its own log). Indeed, this makes it possible:
to customize the maintenance schedule to each item of equipment of the series;
to refresh and anticipate the provisioning of spare parts (nature of the parts and replacement date);
to refresh and anticipate the scheduling of industrial maintenance;
to refresh and anticipate the total cost of future maintenance in the service life of the equipment.

It is also useful to determine at all times:
the limit usage of the equipment compatible with zero failures to be observed during each of the future periods of operation in the life of the equipment;
the residual service life of the equipment (taking into account said future usage and its own log).

Indeed, this allows realistic planning of the usage that can be made of the equipment for the rest of its service life and thus over the long term.

In addition, being able to refresh and anticipate the limit usages of the equipment for the rest of its service life, as well as the total costs of the future optimal maintenance operations, makes it possible to determine at all times the residual value of the equipment from the perspective of a possible resale.

In short, the issue of being able to control the impact of the manufacture, maintenance and usages of the equipment on the reliability of the equipment is significant since this control at least:
unlocks access to the optimization of manufacturing and maintenance;
facilitates interaction with industrial maintenance players;
unlocks access to controlling the reliability of the equipment (by doing away with uncertainty regarding reliability during operation);
unlocks access to control and optimization of the management of the asset that the equipment represents.

### STATE OF THE ART

To this date, the existing methodologies that are best able to influence the reliability of the equipment are:
predictive maintenance;
physical models;
qualification programs on test benches;
feedback (commonly abbreviated to “FB”).

However, these methodologies do not have access to the simulation required to control the impact that manufacturing, maintenance and usage of the equipment have on its reliability. In this sense, they only partially meet the expectations of manufacturers.

Regarding predictive maintenance, this technology observes and analyzes the operation of the equipment, hoping to detect a degradation. Once the degradation has been detected, it constructs a first trend of the evolution of the degradation to display a first prediction of the date of a future failure. This trend of the evolution and this failure date are then fine-tuned with the subsequent observations, iteratively.

In doing so, predictive maintenance includes several methodological biases:
it endeavors to deduce the future behavior of the equipment from the past behavior observed, thus endeavoring to deduce the future result of aging, independently of the past and future causes of aging;
it assumes that future usage will be identical to past usage; this is almost always false;
it uses only operating data, independently of the functional assessment.

Therefore, predictive maintenance is:
vague and slow in its first predictions, requiring an observation time of the order of fifteen days of operation after a maintenance operation;
slow to display a fair prediction;
short-sighted: its prediction horizon is limited to a medium time frame, at most of the order of six months.

Other consequences of its methodological biases, predictive maintenance is insufficiently proactive. Indeed, it only reacts to the appearance of a degradation during operation instead of anticipating the appearance of the degradation. Moreover, it requires the operation of the equipment in order to formulate its predictions, which is an unacceptable operational drawback. More generally, predictive maintenance does without access to any simulation, in particular the simulation of the behavior of the equipment according to the manufacturing or maintenance of the equipment and the projected usage of this equipment.

Predictive maintenance is therefore limited to providing only a prediction of a failure date that is insufficiently precise and proactive. It does not have the ability to provide recommendations in terms of manufacturing, maintenance or usage, in order to optimize the behavior of the equipment, in particular with a view to pushing back the failure date or lengthening the service life.

The various predictive maintenance solutions have been developed with the rise of computing means and the increasing value of data. However, they only make use of the operating data, are affected by the same methodological biases, consequently suffer from the same limitations and there is little difference between them.

Regarding the physical models, the complete and customized modeling of a given item of equipment by the physical models is not realistic from a technical and especially economic point of view. These models are very expensive and cover an excessively restricted field of physical phenomena. In addition, these physical models are vague.

Indeed, a physical model is able to characterize only the behavior of an elementary part of a component of the equipment exposed to a physical phenomenon. This modeling is furthermore an approximation of reality: it includes an element of inaccuracy. Associated with the fundamental research, the development of a physical model also involves considerable resources in terms of time and costs. In addition, to characterize the aging of each of the elementary parts of an item of equipment, before achieving the overall modeling of the equipment, it would also be appropriate to generate a multitude of physical models, of the order of several hundred.

Modeling the behavior of a standard item of equipment of the series by the physical models therefore requires considerable resources in terms of cost and time. In addition, this overall modeling based on these physical models is difficult to customize to the case of each item of equipment, in particular to its own complete log.

Regarding the bench tests, performed during the design of the benchmark equipment of a given series, especially during its qualification, these tests theoretically make it possible to approximate the behavior of the benchmark equipment of the series throughout its service life, for one or more constraints simulating usage and aging. These tests give trends and orders of magnitude: the indication is therefore only vague.

Decorrelated from the specificity of a given item of equipment of the series taken individually (that is to say, not taking into account the manufacturing, maintenance and usage log of a given item of equipment that these tests cannot indeed anticipate), these tests cannot actually characterize the future behavior of this equipment, in response to the future usage that will be made of same, and especially cannot determine the parameters of the maintenance to be performed that would make it possible to optimize the behavior of this equipment during operation.

Indeed, the bench tests consist in characterizing the behavior of the benchmark equipment of the series in question (for example, a steady-state operating point or a response to a transient state), when subjected to one or more given usage and aging profiles: the sampled equipment representative of the series is then subjected to accelerated aging, which is assumed to be representative of actual aging. The characterization of the behavior then remains vague, since the aging during the test is accelerated and the usage taken into account in the course of the test is separate from the actual usages that will be made of each of the items of equipment of the series in the course of their respective life.

The behavior of the benchmark equipment of the series and in particular its service life are thus only approximated.

Regarding feedback, commonly abbreviated to “FB”, it completes the trends and orders of magnitude that are approximated by the bench tests. FB also cannot take into account the specificity of a given item of equipment of the series, in particular its complete log, or therefore characterize the future behavior of the equipment in question in response to a given future usage, and especially cannot determine the maintenance parameters that will optimize the operating behavior thereof. The data from FB is furthermore insufficient due to non-systematic and insufficiently regular operation.

Indeed, FB consists in drawing a comparison between an average behavior, such as the service life, and an average usage. This approach does not make it possible to obtain accurate data.

Furthermore, FB is not systematically utilized. When FB is utilized, it is done so irregularly and the FB refresh frequency is too low, associated with a periodicity of the order of one to two years.

The purpose of the invention is to overcome the disadvantages of the prior art, by proposing a digital system for supervision of the operation and maintenance of at least one item of industrial equipment within a facility, capable of generating and using a behavior model that is specific to the equipment of the series.

This generated behavior model is relevant:
it correlates the causes and the consequences of aging of the equipment;
it is specific to the physical phenomena which each item of equipment of the series hosts;
it can be customized to each item of equipment of the series;
it has the precision of empirical models that are trained with observed data (“data-driven” models).

The behavior model generated is powerful: it makes it possible to simulate the behavior of an item of equipment of the series, for a given maintenance decision and a projected usage of the given item of equipment, especially taking into account the manufacturing, maintenance and usage log of the equipment. The model is all the more powerful as it allows this type of simulation over the long term of the service life of the equipment.

For a given item of equipment of the series in question, taking into account the intended projected usage of the equipment and its manufacturing, maintenance and usage log, the invention thus makes it possible to obtain overall value propositions, especially:
for a given maintenance step of the equipment, the system makes it possible to determine the optimal maintenance decision. This decision is the one that allows an optimal balance between maintenance constraints and the potential for the equipment to have zero failures up to the next maintenance and for the intended projected usage. This optimal decision is furthermore customized to the manufacturing, maintenance and usage log of the equipment;
for a period of operation of the equipment in the course of its service life, the system makes it possible to determine the limit usage, that is to say the maximum possible usage compatible with zero failures up to the next maintenance;
the system makes it possible, during the operation of the facility, to refresh the limit usage of the equipment, taking into account the actual usage of the equipment since its last maintenance and taking into account the intended projected usage up to the next maintenance;
the system similarly makes it possible to determine at all times the schedule of future optimal maintenance of the equipment for the rest of its service life as well as the limit usages of the equipment to be observed for each period of operation over the rest of its service life;
the system determines at all times the date of the end of the service life of the equipment;
finally, the system makes it possible to determine the manufacturing tasks (gestures, parts, settings) that optimize the life of the benchmark equipment of the series, for a given projected usage scenario, in particular a scenario depending on the usage segment crossed with a geographical segment of usage.

To do this, the invention reasons on the scale of an equipment series. For a given series, the invention firstly determines a correlation between causes and consequences of aging of the equipment of the series in question. This correlation links the manufacturing and maintenance log and the usage log of a given item of equipment of the series with the status of this equipment induced by these logs. The determined correlation is specific to the physical phenomena that each item of equipment of the series hosts. Secondly, the invention models this correlation, in the form of a virtual model trained using the manufacturing, maintenance, usage and status data of the equipment of the series in question. In a third step, the invention uses this model as a simulator customized for each item of equipment of the series: the model makes it possible indeed to simulate the status of the equipment at a given instant for a maintenance decision and for the usage which will follow up to this instant, and does so taking into account the manufacturing and maintenance log and the usage log specific to the equipment and preceding the maintenance in question. This model allows access to the value propositions of the invention.

Moreover, by thus modeling the behavior of the standard equipment of the series, the invention correlates, on the scale of the series, the observed behavior of the equipment during the manufacturing, maintenance and usage of each of said items of equipment: the invention is therefore a way to use the feedback. This feedback draws its superior nature from the functional relevance of the modeled correlation. The invention also makes it possible to use the systematic feedback in a continuous or quasi-continuous manner, by resuming the training of the model from the refreshed manufacturing, maintenance, usage and status data of the equipment of the series in question, according to a periodicity determined as best suited, by the designer, the manufacturer, the maintenance technician and the operators.

To this end, the invention relates to a digital system for supervision of the operation and maintenance of at least one item of industrial equipment within a facility, executed by at least one computing terminal.

Advantageously, said system comprises at least the following steps:
installing within a facility at least one item of industrial equipment resulting from a manufacturing process and representative of a series, then at least operating said equipment in the context of a period up to a maintenance step to be performed;
defining at least one projected maintenance subsequent to said maintenance to be performed, after at least one scenario with projected usage conditions of said equipment over a projected period of operation.

Such a system is characterized in that the manufacturing, installation, operation and maintenance of said equipment induce at least:
a manufacturing and maintenance log comprising:
tasks for manufacturing said at least one item of equipment up to said installation;
optionally tasks of at least one prior maintenance of said equipment,
a usage log of said equipment over said period between the installation and said maintenance to be performed, said usage log comprising usage conditions of said equipment during said period;
a status log of said equipment, said status log comprising material indicators of said equipment;
in that
by means of a technical analysis of said equipment, at least one correlation is determined between at least one of said tasks and/or at least one of said usage conditions, and at least one of the material indicators of said status, said correlation establishing at least one link between causes of aging and consequences of aging of the equipment;
in the correlation:
the tasks are characterized by those identified as critical, and/or the usage conditions are characterized by those to which the equipment is sensitive and exposed during operation or when stopped, the tasks and the conditions in question impacting the status of said equipment;
the material status of the equipment is characterized by the indicators identified as being representative of this status of said equipment;
then, in the correlation, the following are determined:
measured physical quantities or functions of the measured physical quantities characterizing the usage conditions to which said equipment is sensitive and exposed during operation or when stopped;
measured physical quantities or functions of the measured physical quantities characterizing the material status of the equipment at a given instant;
and then
for the other equipment of said series, recovering and extracting data associated with these tasks, and data associated with the physical quantities or functions of physical quantities relating to these usage conditions and to these material indicators, as identified in said correlation, so as to obtain a dataset;
training at least one virtual model, on the basis of the dataset.

The system is further characterized in that
during the maintenance of said equipment to be performed, values are submitted to said model:
   of at least one of the tasks of the manufacturing and maintenance log and at least one of the usage conditions of the usage log,
   and of at least one of the tasks of the maintenance to be performed and of said projected usage conditions of the scenario;
said model generating a projected status of said equipment subsequent to said maintenance to be performed, said projected status being compared to a minimal status identified as being required for the operation of said equipment.

### DESCRIPTION OF THE FIGURES

Other features and advantages of the invention will become apparent from the following detailed description of non-limiting embodiments of the invention, with reference to the appended figures, in which:

FIG. 1 schematically depicts a view of an architecture of the system implemented in the supervision of an item of equipment, especially showing, the day before the maintenance to be carried out, the submission to the trained virtual model of the manufacturing and maintenance log and of the usage log of said equipment, as well as of the tasks of the maintenance to be performed and of the projected usage conditions of the scenario, said virtual model generating a projected status of said equipment on the date of the following projected maintenance;

FIG. 2 schematically depicts a view of a detail of the architecture, especially showing a manufacturing and maintenance log comprising the manufacturing decision of the equipment up to its installation, as well as the prior maintenance decisions of the equipment and, additionally, the decisions of the maintenance to be performed and those of the projected maintenance, especially highlighting the tasks of each of said decisions and their timing;

FIG. 3 schematically depicts a view of a detail of the architecture, especially showing the usage log of the equipment between the installation and the maintenance to be performed, as well as the projected usage scenario, highlighting that said usage log and said scenario comprise usage conditions of said equipment associated with their respective period;

FIG. 4 schematically depicts a view of a detail of the architecture, especially showing the log of the successive statuses of the equipment, as well as the successive projected statuses of the equipment, especially highlighting the material indicators of the statuses of the equipment associated with their respective period;

FIG. 5 schematically depicts a view of a detail of the architecture of said supervision system, especially showing the process of recovering and extracting data from one item of equipment of the series and as identified in the correlation to be trained;

FIG. 6 schematically depicts a view of another detail of the architecture, especially showing the process of recovering and extracting data for several items of equipment of the series, so as to obtain a dataset and train the virtual model;

FIG. 7 schematically depicts a view of an architecture of the supervision system, especially showing said virtual model generating at one instant a projected status of said equipment, and its two material indicators, with a comparison with respect to a minimal status identified as being required for the operation of said equipment;

FIG. 8 schematically depicts a view of an example of a calculation of a limit for a projected condition of a usage scenario after maintenance to be performed, limit for which the projected status of the equipment is equivalent to the minimal status, at the time of the following projected maintenance;

FIG. 9 schematically depicts another view of said example of another calculation of another limit for another projected condition of a usage scenario after maintenance to be performed, other limit for which the projected status of the equipment is equivalent to the minimal status, at the time of the following projected maintenance;

FIG. 10 schematically depicts a view of said example with a scale of the values of certain projected usage conditions, in the form of polygons, especially indicating the target values and the maximal limits for said projected conditions associated with said scenario;

FIG. 11 schematically depicts a view of said example with a set of curves on a chart, especially highlighting, from the variation of two of the projected conditions, the maximal limit of a third of the projected conditions;

FIG. 12 schematically depicts a view similar to FIG. 1 of an architecture for the long term, especially showing a first step of recurrently implementing said supervision system in order to predict projected statuses, from a maintenance operation to be performed up to a projected maintenance operation;

FIG. 13 schematically depicts a view similar to FIG. 12 for the long term, especially showing a second step of recurrently implementing said supervision system in order to predict projected statuses, from said projected maintenance operation up to a following projected maintenance operation;

FIG. 14 schematically depicts a simplified view of an example of a prediction for the long term, especially showing curves representative of the evolution of the status of the equipment as a function of time, in the course of two consecutive projected periods;

FIG. 15 schematically depicts a simplified view of an example of a prediction for the long term, especially showing curves representative of the evolution of the status of the equipment as a function of time, in the course of several consecutive projected periods;

FIG. 16 schematically depicts a simplified view of an architecture of the supervision system, especially showing said virtual model determining the instant of a failure date of said equipment, for an insufficient maintenance decision.

### DETAILED DESCRIPTION

The present invention relates to a system 1 for supervision of the operation and maintenance of at least one item of equipment 2 within an industrial facility 3.

Such a supervision system 1, hereinafter “system 1”, is foreseen as digital. In other words, it is at least one software program, intended to be executed by at least one computing terminal.

Usually, such a computing terminal may be of any type, especially a computer server or a computer. In addition, said computing terminal makes it possible through suitable storage means: to record, read, modify and generate data in digital form. Said computing terminal is also foreseen as accessible via a suitable communication network, locally or remotely.

In addition, such a system 1 comprises successive steps, hereinafter described non-exhaustively. According to the invention, the system 1 can therefore be connected to a method.

Some steps are performed in a real manner, especially by a person interacting with said computing terminal, especially via a virtual interface, or else specifically when an operator interacts with said equipment 2.

Other steps are performed virtually, especially when data processing is performed by the computing terminal. Said system 1 therefore involves digital elements, similar to virtual technical means formed and implemented advantageously in the scope of the present invention.

Said system 1 provides the supervision of one item of equipment 2 within one facility 3, of several items of equipment 2 within the same facility 3, or even of several items of equipment 2 within several facilities 3.

As mentioned previously, said equipment 2 is characterized as being essential for the operation of said facility 3. Therefore, the unavailability of the equipment 2 is likely to interrupt the production of the facility 3, to induce or worsen an incident or accidental situation of the facility 3.

Said equipment 2 may be of any type, for example a heat engine, an electric motor, an alternator, a pump, a solenoid valve.

Said equipment 2 therefore forms an integral part of the facility 3 and is necessary for its correct operation.

Such a facility 3 may be mobile, such as machinery or a vehicle (for example a submersible, ship, aircraft or spacecraft), or else stationary, such as a structure or infrastructure (for example an electric power plant, an oil platform or a refinery).

Therefore, the system 1 comprises, as an initial condition, the installation within an industrial facility 3 of at least one item of equipment 2 resulting from a manufacturing process 4 and representative of a series. In other words, the equipment 2 has been integrated at a past time, within the facility 3.

In addition, the manufacturing 4 of the equipment 2 comprises the assembly of several components until obtaining the equipment 2, followed by the installation of the equipment 2. This manufacturing process 4 is preceded by a design 40 of the equipment 2.

It will be noted that the equipment 2 is representative of a series, which comprises all the items of equipment 2 manufactured identically from a single design plan. One fraction of the equipment 2 of the series can no longer be operated, another fraction is currently being operated, and another fraction already manufactured may remain to be installed and operated.

After its installation in the facility 3, said equipment 2 is at least operated in the context of a period 5 up to a maintenance step 6 to be performed. Therefore, said period 5 corresponds to a period of operation of the equipment between the installation and the maintenance 6 to be performed, or else to an alternation of periods of operation and of maintenance steps since the installation.

It will be noted that the maintenance step 6 to be performed is a concrete operation, requiring the intervention of at least one operator on the geographical site of the facility 3 and performed directly on said equipment 2.

In this context and as mentioned previously, the supervision system 1 envisages managing the future life cycle of said equipment 2, namely:
defining the nature of the tasks of the future maintenance of the equipment 2 in order to optimize them and adapt them to the intended usage profile of said equipment 2 and doing so over the long term and for the service life of the equipment 2;
identifying the limit usages compatible with zero failures during operation up to the next maintenance for each projected period of operation 70 of the equipment 2 and doing so over the long term and for the service life of the equipment 2;
refreshing in real time, during operation, the limit usage of the equipment 2, compatible with zero failures;
instructing the extension of the service life of the equipment 2, by defining the nature of the tasks of the last maintenance of the equipment 2 optimized and adapted to the intended usage profile of the equipment 2.

On the scale of the equipment of the series, the supervision system 1 also envisages optimizing the manufacturing of the standard equipment representative of the series in order to adapt it to a given usage profile, namely determining the manufacturing parameters 4 that optimize the life cycle of the equipment 2.

Therefore, at least one projected maintenance 7 subsequent to said maintenance 6 to be performed is defined.

The future period that runs between said maintenance 6 to be performed and said projected maintenance 7 corresponds to at least one projected period of operation 70 wherein the equipment 2 is operated in at least one scenario 8 characterized by projected usage conditions 110, referred to as “projected conditions 110”. The future period may also correspond to an alternation of projected periods of operations and maintenance steps.

The future period may extend to the date of the end of the service life of the equipment.

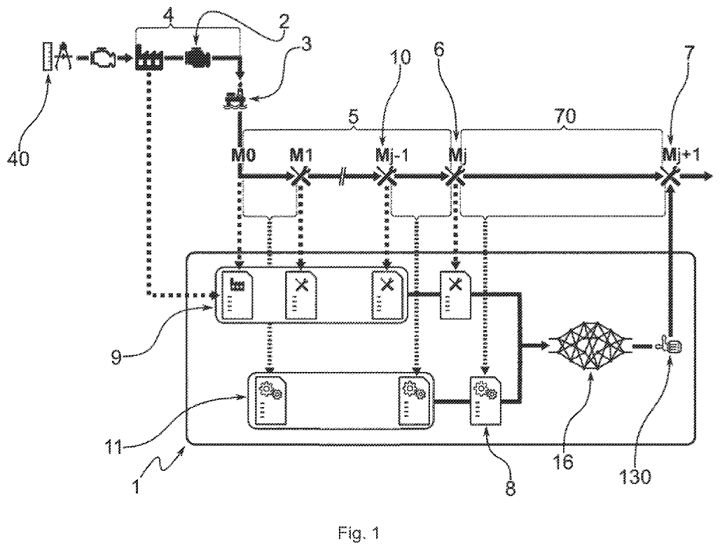

FIG. 1 especially shows the design 40 and the manufacturing process 4 of the equipment 2, the period 5 (between the installation of said equipment 2 in the facility 3 and the maintenance 6 to be performed and comprising any prior maintenance 10), the projected period 70 up to a projected maintenance 7.

This being the case, the steps of the manufacturing process 4 and the installation of said equipment 2, and then the steps of operating and maintaining said equipment 2 in the course of the period 5, generate several types of data that the supervision system 1 takes into consideration.

The manufacture, installation, operation and maintenance of said equipment 2 induce at least one manufacturing and maintenance log 9 (or “log 9”) which comprises:
tasks 90 for manufacturing said equipment 2 up to said installation;
optionally tasks 90 of at least one prior maintenance 10 of said equipment 2.

In other words, the manufacturing and installation steps comprise at least manufacturing and installation tasks 90. Furthermore, the period 5 optionally comprises at least one prior maintenance 10 of said equipment 2 which comprises maintenance tasks 90. All of the manufacturing tasks 90 of said at least one item of equipment 2 up to said installation as well as any tasks 90 of at least one prior maintenance 10 of said equipment 2 generate a manufacturing and maintenance log 9.

It will be noted that the manufacturing tasks 90 as well as the tasks 90 of each of the maintenance operations 10, are defined in a non-limiting manner by gestures performed by an operator, by parts mounted during manufacturing or removed during a maintenance step to be replaced, as well as by adjustments of said equipment 2.

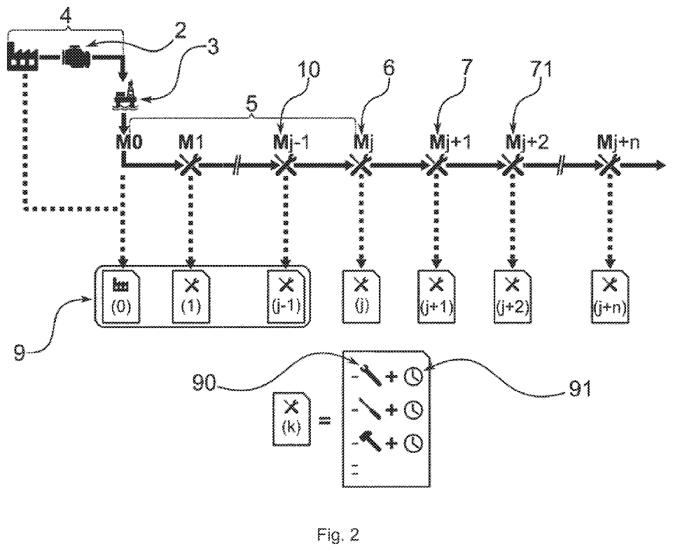

As can be seen in FIG. 2, the system 1 especially comprises:
the manufacturing and maintenance log 9, that is to say the log of manufacturing and maintenance decisions executed in respect of the manufacturing process 4 and the installation (of rank 0) and in respect of the prior maintenance 10 (from rank 1 to rank j−1);
a maintenance decision in respect of the maintenance 6 to be performed (of rank j);
a maintenance decision in respect of the projected maintenance 7 (of rank j+1).

Each manufacturing or maintenance decision of rank k is characterized by its ratio to the various possible tasks 90 (optional performance of said task 90, characterization of said task 90 when performed, timer 91 characterizing the duration after which said task 90 was performed on the item of equipment 2).

Further, said steps also induce a usage log 11 (or “log 11”) of the equipment 2 over the period 5 between said installation and said maintenance 6 to be performed. Said usage log 11 comprises conditions 110 for using said equipment 2 during said period 5 (also referred to as “conditions 110”).

Indeed, the period 5 between the installation of the equipment 2 and the maintenance 6 to be performed comprises at least one period of operation of the equipment 2 in the context of a usage.

This usage is associated with the way in which the equipment has been used, namely the set of usage conditions 110 of said equipment 2 during said period.

For example, in the case of an item of equipment 2 corresponding to the engine of a facility 3 such as a truck, these usage conditions 110 can be the load transported, the mileage traveled, the speed, the ambient air temperature, the average gradient of the routes used.

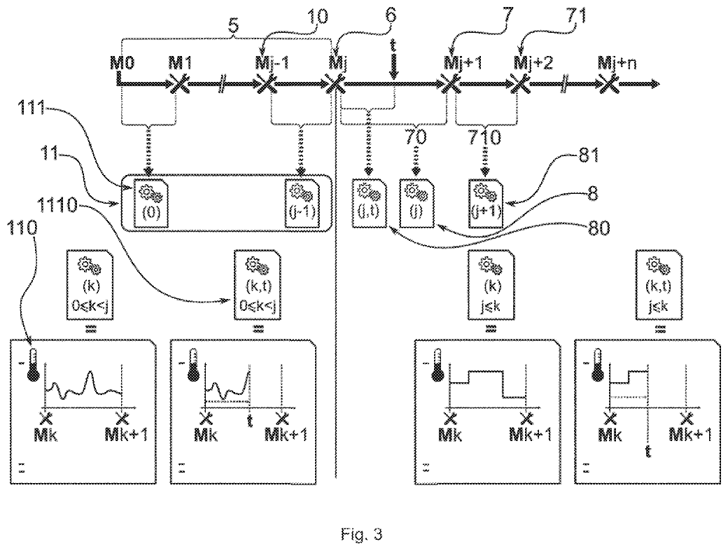

This usage thus generates the usage log 11 of said equipment over the period 5 between the installation and said maintenance 6 to be performed. As can be seen in FIG. 3, illustrating the case of an item of equipment 2 such as a pump (for which one of the conditions 110 is the temperature), the system 1 comprises especially:
the usage log 11 of the equipment 2 in the course of the period 5 (from the installation of rank 0 to the maintenance 6 to be performed of rank j);
the scenario 8 for usage of the item of equipment 2 as foreseen over the projected period 70.

The usage log 11 can be broken down into the set of usage sub-logs 111 of the equipment 2. The usage sub-log 111 of rank k represents the fraction of the usage log 11 of the equipment 2 in the course of the period of operation comprised between the two successive prior maintenance operations 10 of rank k and rank k+1. In particular, FIG. 3 highlights:
the usage sub-log 111 of rank 0 (between the installation of rank 0 and the prior maintenance 10 of rank 1);
the usage sub-log 111 of rank j−1 (between the last prior maintenance operation 10 of rank j−1 and the maintenance 6 to be performed of rank j).

The log 11 comprises all of the usage sub-logs 111 from rank 0 to rank j−1.

The usage sub-log 111 of rank k represents the evolution of each of the usage conditions 110 between two prior maintenance operations 10 of rank k and rank k+1, such as for example the evolution of the temperature over time (as can be seen in FIG. 3).

In the usage sub-log 111 of rank k of the item of equipment 2, it is possible to distinguish the partial usage sub-log 1110 of the item of equipment 2 of rank (k,t), that is to say the evolution of each of the usage conditions 110 between the prior maintenance 10 of rank k and the instant (t), for an instant (t) comprised between the maintenance of rank k and the maintenance of rank k+1. The scenario 8 represents the projected evolution of each of the projected usage conditions 110, in the context of the projected usage of the equipment 2 between the maintenance 6 to be performed (rank j) and the projected maintenance 7 (rank j+1), as can be seen in FIG. 3. In the scenario 8, it is possible to distinguish a partial scenario 80. The partial scenario 80 of rank (j,t) represents the projected evolution of each of the projected conditions 110 of the equipment 2 between the maintenance 6 to be performed of rank j and the instant (t), for an instant (t) comprised between the maintenance 6 to be performed of rank j and the projected maintenance 7 of rank j+1.

Moreover, said steps also induce a status log 12 of said equipment 2 (or “log 12”) which comprises material indicators 120 of said equipment 2 (or “indicators 120”).

Indeed, the usage of the equipment 2 induces an aging which has an impact on the status 13 of the equipment 2. The status 13 of the equipment 2 at a given instant, characterized by the material indicators 120, reflects the physical integrity of the equipment 2, on which its ability to operate depends. All the statuses 13 of the equipment 2 (or all the material indicators 120) that actually occurred in the course of the period 5 constitute the status log 12 of the item of equipment 2.

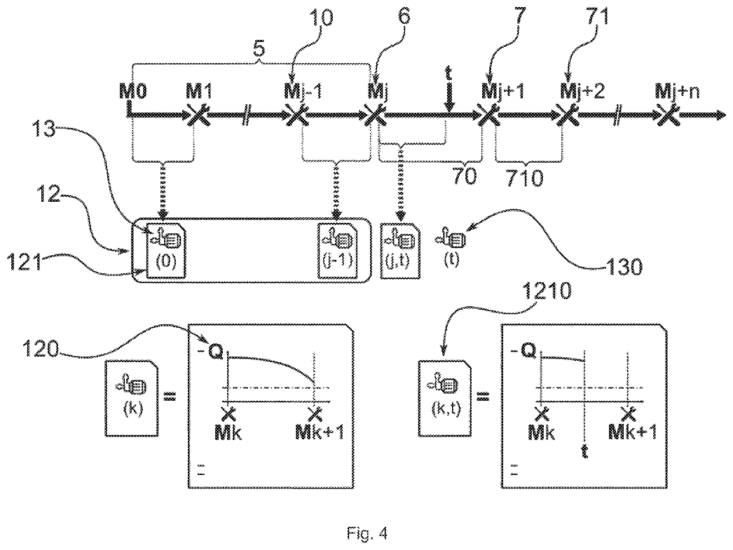

As can be seen in FIG. 4, illustrating the case of an item of equipment 2 such as a pump (for which one of the material indicators 120 is the flow rate (Q)), the system 1 comprises especially the status log 12 of the equipment 2 in the course of the period 5. The status log 12 can be broken down into the set of status sub-logs 121. The status sub-log 121 of rank k of the equipment 2 represents the fraction of the status log 12 in the course of the period of operation comprised between the two successive prior maintenance operations 10 of rank k and of rank k+1. In particular, FIG. 4 highlights:
the status sub-log 121 of rank 0 (between the installation at rank 0 and the prior maintenance 10 of rank 1);
the status sub-log 121 of rank j−1 (between the last prior maintenance 10 of rank j−1 and the maintenance 6 to be performed of rank j).

The log 12 comprises all of the status sub-logs 121 from rank 0 to rank j−1. As can be seen in FIG. 4, the status sub-log 121 of rank k of the equipment 2 represents the evolution of the successive statuses 13 of the equipment 2, between the two prior maintenance operations 10 of rank k and rank k+1. The status sub-log 121 of rank k of the equipment 2 represents the evolution of each of the material indicators 120 (for example, the evolution of the flow rate over time) between the two prior maintenance operations 10 of rank k and rank k+1. As can be seen in FIG. 4, it is possible to distinguish, in the status sub-log 121 of rank k of the equipment 2, the partial status sub-log 1210. The partial status sub-log 1210 of rank (k,t) represents the evolution of each of the material indicators 120 between the prior maintenance 10 of rank k and the instant (t) (for an instant (t) between the maintenance of rank k and the maintenance of rank k+1).

Thus, the logs 9, 11, 12 extend in time in the course of the period 5. They comprise, respectively, the manufacturing and maintenance tasks 90, usage conditions 110 and material indicators 120.

The aforementioned elements of the logs 9, 11, 12 represent designations of computing fields, in which measured values coming from said equipment 2 have been recorded successively over time.

Advantageously, in a first step, at least one correlation 14 is determined between at least one of said manufacturing and maintenance tasks 90, and/or at least one of said usage conditions 110, as well as at least one of the material indicators 120 of said status 13. Said correlation 14 establishes at least one link between causes of aging and consequences of aging of the equipment 2.

In other words, the invention chooses to approximate the behavior of an item of equipment 2 from the viewpoint of the causes and consequences of aging.

For this reason, the invention chooses to characterize the causes of aging of the equipment 2 by the manufacturing and maintenance log 9 of the equipment 2, as well as by the usage log 11 of the equipment 2. The invention furthermore chooses to characterize the consequences of aging of the equipment 2 by the status 13 of the equipment 2 induced by said logs 9 and 11.

The invention therefore chooses to correlate the status 13 of the equipment 2 with the manufacturing and maintenance log 9 and the usage log 11 of the equipment 2.

Thus, the invention foresees correlating the manufacturing and maintenance log 9 (hereinafter referred to as “first term” of said correlation 14) and the usage log 11 (hereinafter referred to as “second term” of said correlation 14) of a given item of equipment 2 of the series with the status 13 of this equipment 2 (hereinafter referred to as “third term” of said correlation 14) induced by these logs 9, 11—said three terms of said correlation 14 constituting a triplet 140.

For example, the case of an item of equipment 2 such as a pump that is sensitive to the temperature of the fluid conveyed is considered. The invention correlates the usage log of the pump (characterized by the fluid temperature log and/or suction pressure log and/or pump speed log) as well as the main manufacturing options of the pump (such as the type of impeller mounted) and the maintenance log of the pump (such as the log of impeller replacements during the various prior maintenance operations 10) with the status of the pump (characterized by its flow rate and/or the delivery pressure).

Further, the correlation 14 aims only to consider the relevant parameters that are likely to influence the aging and the operation of the equipment 2, the other parameters not being appropriate to select.

For this reason, a technical analysis of the equipment 2 is conducted to identify the critical manufacturing and maintenance tasks 90 as well as the usage conditions 110 that have an impact on the status 13 of the equipment 2.

To do this, by means of the technical analysis of the equipment 2, the manufacturing and maintenance tasks 90 are characterized by those identified as critical, as defined hereinafter.

More precisely, the invention chooses to characterize the tasks 90 of the manufacturing and maintenance log 9 of the equipment 2 in at least one of the following ways:
for the manufacturing process 4 of the equipment 2, the invention characterizes the gestures set, the parts mounted or even the adjustments adopted during the manufacturing process. The gestures of the manufacturing process are characterized by the protocol option for each manufacturing gesture, if there are several possible protocol options for said gesture for the manufacturing process 4 of the equipment 2 of the series. The parts mounted during the manufacturing process are characterized by the mounted part option, if there are several possible options for said part for the manufacturing 4 of the equipment 2 of the series (for example: if the manufacturing of the series of pumps foresees two possible types of pump bearing). The adjustments adopted during the manufacturing process are characterized by the value of each adjustment, if there are several possible values of said adjustment for the manufacturing 4 of the equipment 2 of the series (for example: the tightening torque of the pump gland);
for a maintenance step of the equipment 2, the invention characterizes the gestures set, the parts mounted or even the adjustments adopted during each maintenance step. The maintenance gestures include replacing a part of the other maintenance tasks 90 (for example: retightening connections of an electrical terminal block). The replacement of the part during the maintenance in question is characterized by the part option, if there are several possible options for said part for the maintenance of the equipment 2 of the series (for example: if the series of pumps foresees two possible types of pump bearing). The adjustments adopted during the maintenance in question are characterized by the value of each adjustment, if there are several possible values of said adjustment for the maintenance of the equipment 2 of the series (for example the tightening torque of the pump gland).

In addition, and according to one embodiment, in the correlation 14, the manufacturing and maintenance log 9 is reduced to a log of the critical tasks 90 in the form of at least one list of successive values.

In other words, and by means of the technical analysis of the equipment 2, the invention chooses to characterize the manufacturing and maintenance log 9 of the equipment 2 by considering only the critical tasks 90, namely the gestures, parts and adjustments identified as determining the behavior of the equipment 2 during operation (i.e., as having an impact on the aging and thus on the status 13 of the equipment 2).

In addition, the manufacturing and maintenance log 9 of the equipment 2 (up to and including the last prior maintenance operation 10) is characterized by listing, for each critical task 90, the values which have been successively adopted during the manufacturing process 4 and during the various successive prior maintenance operations 10 in the life of the equipment 2 and up to the last prior maintenance operation 10 (the one preceding the maintenance 6 to be performed). The manufacturing and maintenance log 9 is thus characterized by a list of values. For example, the case of an item of equipment 2 such as a pump is considered, comprising a bearing and for which the placement or replacement as well as the nature of the pump bearing correspond to a critical manufacturing and maintenance task 90 of the pump. In the example, it is considered that the last prior maintenance 10 (the one preceding the maintenance 6 to be performed) is the seventh (of rank k=7). The invention characterizes the log of this critical manufacturing and maintenance task 90 by the list [A,0,0,B,0,0,B,0], to indicate the placement of a type-A bearing in the manufacturing operation 4, the replacement of the bearing with a new type-B bearing in the third maintenance operation, the replacement of the bearing with a new type-B bearing in the sixth maintenance operation, as well as the fact that no maintenance action has been performed on the bearing in the other prior maintenance operations 10. The invention therefore chooses to characterize the manufacturing and maintenance log 9 of the equipment 2 by a matrix consisting of lists, each list being associated with one critical task 90 and listing the successive values characterizing this critical task 90 according to the manufacturing process 4 and then the various maintenance operations of the equipment 2 up to and including the last prior maintenance operation 10. For example, the aforementioned case of an item of equipment 2 such as a pump is considered, wherein the manufacturing and maintenance log 9 can be reduced to the log of the two critical tasks 90 “placement or replacement of the pump bearing” and “placement or replacement of the pump impeller”, and having as respective log lists after the seventh maintenance operation the lists [C,0,A,0,0,B,0,C] and [A,0,0,B,0,0, B,0]. The manufacturing and maintenance log 9 of the pump in question up to and including the seventh maintenance operation then corresponds to the matrix [[C,0,A,0,0,B,0,C]; [A,0,0,B,0,0,B,0]].

In addition, the usage conditions 110 are characterized by those to which the equipment 2 is sensitive and exposed during operation or when stopped.

Indeed, by means of the technical analysis of the equipment 2, the invention reduces the conditions 110 to the ambient conditions and/or to the operating conditions (CA/CF) to which the equipment 2 is sensitive and exposed during operation or when stopped.

The ambient conditions (CA) are understood to be conditions of the environment outside the equipment 2 and to which the equipment 2 is sensitive and exposed during operation or when stopped (such as the ambient air temperature, the hygrometry, the rate of irradiation).

The operating conditions (CF) are to be understood to be as follows:
the conditions inside the equipment 2 and to which the equipment 2 is sensitive and exposed during operation or when stopped (such as the temperature of the fluid conveyed, the level of vibration in the case of a pump); and/or
the parameters representative of the power deployed by the equipment 2 during operation and which have an impact on its operating point (such as the load transported, the speed in the case of a truck engine); and/or
the other parameters necessary for characterizing the sum of the work to which the equipment 2 was subjected under the aforementioned ambient and operating conditions (CA/CF) (such as the total mileage traveled in the case of a truck, or else as generally the time of usage of the equipment 2).

For example, the case of an item of equipment 2 such as a pump is considered, the impeller of which is made of thermoplastic material and accordingly sensitive and exposed to the temperature of the fluid conveyed. The temperature of the fluid conveyed is then even more important to be taken into account as an operating condition than in the case of a pump in which the impeller is made of metal.

Within the meaning of the invention, the scenario 8 and the projected usage conditions 110 are characterized by the same ambient and operating conditions (CA/CF) to which the equipment 2 is sensitive and exposed during operation or when stopped.

In addition, the material status 13 of the equipment 2 is characterized by the material indicators 120 identified as being representative of this status 13 of said equipment 2.

To do this and by means of the technical analysis of the equipment 2, the invention chooses to characterize the status of the equipment 2 at the instant by the necessary and sufficient set of performance, vibratory behavior and other material indicators 120 (for example, and in a non-limiting manner, the material indicators usually measured by non-destructive testing techniques), judged to be representative of the status 13 of the equipment 2.

In order to characterize the correlation 14 and in particular the log of the conditions 110, as specifically as possible to the equipment 2 in question, the measured physical quantities or the functions of the measured physical quantities are determined, characterizing the conditions 110 to which said equipment 2 is sensitive and exposed during operation or when stopped or best characterizing the log of these usage conditions 110 (i.e., the usage log 11).

These functions of physical quantities comprise several mathematical or algorithmic functions. In other words, each condition 110 has a measured physical quantity associated with it that characterizes this condition. Thus, when relevant, the invention characterizes the log of the condition by the log of this physical quantity.

For example, if the equipment 2 is sensitive and exposed to the ambient air temperature or to the temperature of the fluid conveyed in the case of a pump, the log of the corresponding temperature is therefore considered. Further, the invention also chooses to characterize the log of a condition 110 by the log of a function of the physical quantity representative of the condition 110, when this characterization is more relevant than the log of this physical quantity.

For example, if the equipment 2 is sensitive and exposed to the ambient air temperature or else to the temperature of the fluid conveyed (as in the case of a pump), it is then possible to integrate the log of the temperature into the time integral of the temperature over the duration between the installation of the equipment 2 in the facility 3 and the instant.

Further, when the invention chooses to characterize the log of a condition 110 by the log of a function of the physical quantity representative of said condition, these functions may comprise, in a non-limiting manner, a calculation of the time of presence of the physical quantity measured in at least one range of values.

Indeed, the invention chooses to consider that the aggregate of abnormal transients impacts the aging and thus the behavior of the equipment 2. Thus, when relevant, the invention characterizes the log of a condition 110 by counting the times of presence of this condition respectively in the normal operating range, in the range close to destruction, or even in the intermediate range between the preceding two.

For example, the case of an item of equipment 2 such as a pump that is sensitive and exposed to the temperature of the fluid conveyed is considered. It is then possible to characterize the log of the temperature by the time integral of the temperature over the duration between the installation of the equipment 2 in the facility 3 and up to the instant, distinguishing the component of said integral within the normal operating range, from the component within the range close to destruction, from the component within the intermediate range between the two preceding domains. When the invention chooses to characterize the log of a condition 110 by the log of a function of the physical quantity representative of said condition, these functions may also comprise, in a non-limiting manner, a calculation representative of at least one fluctuation of the measured physical quantities and/or a counting of said at least one fluctuation.

This is, in particular, the case when the equipment 2 is sensitive and exposed to variations of a condition 110. In a non-limiting manner, such functions can then correspond to the gradient function or to the counting of the cycles of the condition in question.

In the first example, the case of an item of equipment 2 such as a pump that is sensitive and exposed to the temperature of the fluid conveyed and in particular to the sudden variations in said temperature is considered. To characterize the log of the condition 110 up to a given instant, the average gradient of this temperature can be calculated (example: an average variation of 20° C./min “degrees Celsius per minute”) during temperature transients (i.e., during transients inducing sudden temperature variations). It is then possible to associate this average gradient with a counting of similar transients (for example: 2000 sudden temperature transients associated with an average gradient of 20° C./min from the installation up to said instant).

Instead of the average of the log of the values of the gradient of this temperature, it is also possible to resort to any other statistical function as median and standard deviation.

In another example, the case of an item of equipment 2 such as a metal boiler tank is considered, which is sensitive and exposed to the temperature of the fluid contained and in particular subjected to temperature cycles (i.e., subjected to high-amplitude temperature variations in the course of heating or cooling, for example between 200° C. and 80° C.) and sensitive to these cycles. Said cycles can then be counted (for example: 20 temperature cycles from installation up to an instant) and this counting of similar cycles can be associated with the average of the amplitudes of the cycles in the log of said tank (example: the average cycle amplitude of 150° C. over the 20 cycles).

Instead of the average of the log of the amplitudes, it is also possible to resort to any other statistical function, such as a median and a standard deviation. When the invention chooses to characterize the log of a condition 110 by the log of a function of the physical quantity representative of said condition 10, these functions may also comprise, in a non-limiting manner, a counting of said at least one fluctuation.

This is the case in particular when the equipment is sensitive to shutdown or start-up transients. The counting of such transients is then useful for characterizing the usage log 11. Similarly, when equipment 2 continues to age while said equipment is stopped, the counting of the duration of the stoppage is also useful for characterizing the usage log. Similarly, to characterize the correlation 14 and in particular the status 13 of the equipment 2 at an instant, as specifically as possible for the equipment 2 in question, the measured physical quantities or functions of these measured physical quantities characterizing the material status 13 of the equipment 2 at said instant are also determined.

For example, the case of an item of equipment 2 such as a centrifugal pump is considered. The status of the pump can then be characterized at the instant by means of the instantaneous flow rate as well as the instantaneous delivery pressure. In this step and by means of a technical analysis of the equipment 2, the invention has thus determined the critical manufacturing and maintenance tasks 90 specific to the equipment 2 for best characterizing the manufacturing and maintenance log 9 of the equipment 2. The usage conditions 110 specific to the equipment 2, as well as the physical quantities or physical quantity functions that best characterize said conditions 110 as well as the usage log 11 of the equipment 2 have similarly been determined.

The material indicators 120 that best characterize the status 13 of the equipment 2 at any instant, as well as the physical quantities or physical quantity functions that best characterize said material indicators 120 at said instant have similarly been determined.

This technical analysis of the equipment 2 thus makes it possible to determine the correlation 14 in a form that is specific to the equipment 2. As a result, the correlation 14 determined is indeed specific to the physical phenomena that each item of equipment 2 of the series hosts. Thus, according to one embodiment, in the correlation 14, the functions of the measured physical quantities of the usage conditions 110 comprise a calculation of the time of presence of the measured physical quantities in at least one range of values; and/or a calculation representative of at least one fluctuation of the measured physical quantities; and/or a counting of said at least one fluctuation.

Previously, in the correlation 14, the invention chooses to characterize the manufacturing and maintenance log 9 of the equipment 2 (up to and including the last prior maintenance operation 10), by listing, for at least one (preferably each) critical manufacturing and maintenance task 90, the values which have been successively adopted during the manufacturing and the various successive prior maintenance operations 10 in the life of the equipment 2, up to and including the last prior maintenance operation 10. The log of each critical task 90 is thus characterized by a list of values. For example, the aforementioned case of an item of equipment 2 such as a pump comprising a bearing and for which the placement or replacement as well as the nature of the pump bearing correspond to a critical task 90 for manufacturing and maintaining the pump is considered. In the example, it is considered that the last prior maintenance 10 (the one preceding the maintenance 6 to be performed) is the seventh (of rank k=7). The invention characterizes the log of this critical manufacturing and maintenance task 90 by the list [A,0,0,B,0,0,B,0], to indicate the placement of a type-A bearing in the manufacturing operation 4, the replacement of the bearing with a new type-B bearing in the third maintenance operation, the replacement of the bearing with a new type-B bearing in the sixth maintenance operation, as well as the fact that no maintenance action has been performed on the bearing in the other maintenance operations.

The manufacturing and maintenance log 9 of the equipment 2 is thus a matrix grouping together for each critical task 90 said corresponding list of values. Further, with the aim of reducing the matrix characterizing the manufacturing and maintenance log 9 (up to the last prior maintenance operation 10) to the necessary and sufficient information and with a volume of information that is independent of the rank of the last prior maintenance operation 10, the invention adopts the following principle, herein referred to as “persistent parameter principle”. According to one embodiment, in the correlation 14, having reduced the manufacturing and maintenance log 9 to a log of the critical tasks 90 in the form of at least one list of successive values, in each list, only the persistent value is chosen as being the value adopted in the last maintenance operation during which the task 90 in question was performed and only the persistent values are kept in the log of critical tasks 90. In other words, in the manufacturing and maintenance log 9 and for each critical manufacturing and maintenance task 90:
the persistent value of said task 90 is considered as being the value adopted for said task 90, in the last manufacturing or maintenance step during which said task 90 was performed (in the manufacturing step or in the prior maintenance step 10);
only the persistent value of said task is kept, in the manufacturing and maintenance log 9.

In its final form, the manufacturing and maintenance log 9 is thus reduced to a list of values, that is to say consisting of the persistent values of the critical tasks 90 (or else one persistent value per critical task 90). In doing so, the invention reduces the manufacturing and maintenance log 9 of the equipment 2, by characterizing said manufacturing and maintenance log 9 only by the values of the critical tasks 90 that determine the behavior of the equipment 2 during operation after the last prior maintenance operation 10 in question. In practice, in the manufacturing and maintenance log 9:
the value characterizing each manufacturing and maintenance task 90 performed in the course of the last prior maintenance operation 10 overwrites the series of values characterizing the log of said task 90 (from the manufacturing process 4 until the maintenance preceding the last prior maintenance operation 10);
from the manufacturing process 4 and prior maintenance operations 10 preceding the last prior maintenance operation 10, for each task 90 which has not been performed in said last prior maintenance operation 10, only the value characterizing the last performance of said task 90 is kept.

For example, the case of an item of equipment 2 such as a pump is considered, for which the “placement or replacement of the pump bearing” task as well as the “placement or replacement of the pump impeller” task are the only two critical manufacturing and maintenance tasks 90.

If the log of the “placement or replacement of the pump bearing” task after the seventh prior maintenance operation 10 is characterized by the list [A,0,0,B,0,0,B,0], the persistent value for said task 90 is then “B”, namely the value of the task 90 adopted during the last maintenance operation wherein the task 90 in question was performed (in this example, during the sixth maintenance operation).

If the log of the “placement or replacement of the pump impeller” task after the seventh prior maintenance operation 10 is characterized by the list [C,0,A,0,0,B,0,C], the persistent value for said task 90 is then “C”, namely the value of the task 90 adopted during the last maintenance operation wherein the task 90 in question was performed (in this example, during the seventh maintenance).

The manufacturing and maintenance log 9 of the pump after the seventh maintenance operation is then written [B;C], wherein the first term indicates the persistent value of the “placement or replacement of the pump bearing” task and the second term refers to the persistent value of the “placement or replacement of the pump impeller” task.

In other words, the invention thus reduces the manufacturing and maintenance log 9 of the equipment 2 (up to and including the last prior maintenance operation 10), to the configuration in which the equipment 2 stands after the last prior maintenance operation 10. In doing so, the invention characterizes the manufacturing and maintenance log 9 (up to the last prior maintenance operation 10) by means of a vector whose size is independent of the rank of said last prior maintenance operation 10. It will be noted that the invention can take into account the timing of the recorded values, for example in the form of a time stamp of the data.

In the characterization of the manufacturing and maintenance log 9, this timing can result in a timer 91 added to each critical persistent value of the task 90, said timer 91 characterizing the duration since said task 90 was performed on the equipment 2. In this step, the correlation 14 previously determined in a form specific to the equipment 2 (therefore specific to any standard equipment of the series), by virtue of the technical analysis of the equipment 2, is then determined in a format that lends itself to computer processing, in particular by machine-learning algorithms.

Once the technical analysis of the equipment 2 has been performed, the correlation 14 specific to the series is identified. The following are then determined:
in the first term of the correlation 14: the critical manufacturing and maintenance tasks 90 that best characterize the manufacturing and maintenance log 9 of the equipment 2;
in the second term of the correlation 14: the physical quantities or functions of physical quantity that best characterize the conditions 110 and the usage log 11 of the equipment 2;
in the third term of the correlation 14: the physical quantities or functions of physical quantity that best characterize the material indicators 120 and the log 12 of the status 13 of the equipment 2.

Said critical tasks 90, physical quantities or functions of physical quantities identified in the correlation 14, indicate the raw data (measured and logged for each item of equipment 2 of the series) to be extracted initially from the logs 9, 11, 12 of the equipment 2. The invention therefore foresees consulting this accessible information coming from all the equipment 2 of the series in question. For all the equipment 2 of said series, the data associated with these tasks 90, as well as the data associated with the physical quantities or functions of physical quantities relating to the usage conditions 110 and to the material indicators 120, as identified in said correlation 14, are recovered and extracted, so as to constitute triplets 140 of data and obtain a raw dataset 150. For each item of equipment 2 of the series and for each instant of their respective log 11, the three terms of the triplet 140 associated with the instant are:
the manufacturing and maintenance set 95 of said equipment 2, that is to say, the fraction of the manufacturing and maintenance log 9 up to the last prior maintenance 10 preceding said instant;
the usage set 115 of said equipment 2, that is, the fraction of the usage log 11 up to said instant;
the status 13 of said equipment 2 at said instant. As for the functions of physical quantities identified in the correlation 14, they indicate the conversions 141 to be applied secondly to each of the triplets 140 of the raw dataset 150, in order to constitute a final dataset 15 to be considered in order to model the correlation 14 via a virtual model 16. For example, the case of an item of equipment 2 such as a pump is considered for which the terms of the correlation 14 specific to the series of said pump are thus characterized:
the manufacturing and maintenance log 9 is characterized by the critical tasks 90 relating to the bearing and the impeller of the pump;
the usage log 11 up to the instant is characterized by a first time integral (INT1(t)) of the temperature over the duration between the installation and the instant and by a second time integral (INT2(t)) of the suction pressure over the duration comprised between the installation and the instant, as well as the average value of the temperature gradients (VMG(t)) over the duration between the installation and the instant, associated with the number of sudden temperature transients (NTB(t)) over the same duration;
the status 13 at the instant characterized by the instantaneous values of flow rate and delivery pressure.

The data to be extracted from the logs 9, 11, 12 of each pump of the series in question and for each instant of their respective usage log 11 are then:
in respect of first term of the correlation 14: the type of bearing and the type of impeller in place at the instant, to be extracted from the manufacturing and maintenance log 9;
in respect of second term of the correlation 14: the values at the instant considered of the physical quantities: temperature, suction pressure, to be extracted from the usage log 11;
in respect of third term of the correlation 14: the values at the instant considered of the physical quantities: delivery pressure and flow rate, to be extracted from the status log 12. Once extracted, these data make it possible to construct, for each pump and for each instant (t) of their respective usage log 11, the three terms of the triplet 140 associated with the instant, namely:
the manufacturing and maintenance set 95 of the pump, that is to say, the fraction of the manufacturing and maintenance log 9, over the duration between the manufacturing process 4 and the last prior maintenance 10 preceding said instant (t). The manufacturing and maintenance set 95 is, in the example, the log of tasks 90 (relating to the bearing and to the impeller of the pump) successively performed in the course of said duration, or else the matrix of two lists, one associated with the bearing and the other with the impeller of the pump, each list listing the successive values (type of bearing in place; type of impeller in place) characterizing the critical tasks 90 performed during said period;
the usage set 115 of the pump, that is to say, in the example, the temperature and suction pressure values logged from the installation up to said instant (t);
the status 13 of the pump at said instant (t), that is to say, in the example, the flow rate and the delivery pressure at said instant (t).

Thus, as many triplets 140 as instants considered and pumps of the series are obtained: all these triplets 140 form the raw dataset 150. Secondly, for each pump of the series and each triplet 140 associated with an instant, the manufacturing and maintenance set 95 of the pump up to the instant is converted, in the form of a vector, associated with the instant and indicating the persistent value of each critical task 90. The corresponding vector is then, for each instant considered, [type of bearing in place at the instant; type of impeller in place at the instant] each term of the vector being associated with its own timer 91. Similarly, for each pump of the series and each triplet 140 associated with an instant, the usage set 115 of the pump up to the instant is converted. Since the functions of physical quantity identified in the correlation 14 are, in the example, the integrals (INT1(t), INT2(t)) in the temperature and suction pressure time, the average value of the temperature gradients (VMG(t)) associated with the number of sudden temperature transients (NTB(t)), the conversions 141 to be applied to the raw data, temperature and suction pressure, extracted from the usage log 11, are:
calculating the time integrals of temperature and suction pressure over the duration between the installation and the instant;
calculating the average value of the temperature gradients over the same duration and the number of sudden temperature transients over the same duration.

For each pump of the series and each instant, the usage set 115 of the pump between the installation and the instant is thus converted in the form of a digital vector [INT1(t), INT2(t), VMG(t), NTB(t)] associated with the instant (t). Next, for each pump of the series and each instant, the status 13 of the pump at the instant is indicated in the form of a digital vector associated with the instant [flow rate, delivery pressure]. Finally, each of the triplets 140 (associated with the various pumps (k) belonging to the series and with the various instants (t) of their respective usage log 11) is therefore converted in the form of a vector [Mj(t)(k); Vu(t)(k); Status(t)(k)], with:
Mj(t)(k), vector representing the manufacturing and maintenance set 95 of the pump (k) up to the instant, in the form [type of bearing; type of wheel] each term of the vector being associated with its timer 91;
Vu(t)(k), vector representing the usage set 115 of the pump (k) between the installation and the instant, in the form [INT1(t), INT2(t), VMG(t), NTB(t)];
Status(t)(k), vector representing the status 13 of the pump (k) at the instant, in the form [flow rate, delivery pressure].

The raw dataset 150 is thus converted in the form of the final dataset 15, namely: the set of vectors [Mj(t)(k); Vu(t)(k); Status(t)(k)] for any pump (k) belonging to the series and for any instant (t) of their respective usage log 11. In short, the system 1 foresees recovering and processing only the data considered to be relevant, identified in the correlation 14. Optionally, the system 1 can recover all the data relating to the logs 9, 11, 12 of the equipment 2, in order to extract and then process only those that are relevant, as mentioned above. The system 1 thus converts the raw dataset 150 into a dataset 15, associated with the correlation 14 specific to the series in question. The system 1 has this dataset 15 as the input of a machine-learning project 142: at least one virtual model 16 is then trained, on the basis of the dataset 15. Similarly to the correlation 14, the virtual model 16 obtained is then specific to the series of items of equipment 2 in question. It additionally has the precision of the empirical models (data-driven models).

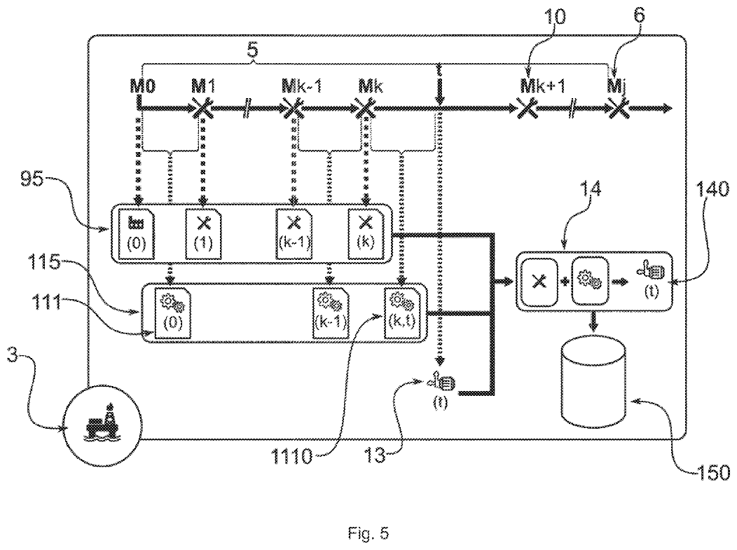

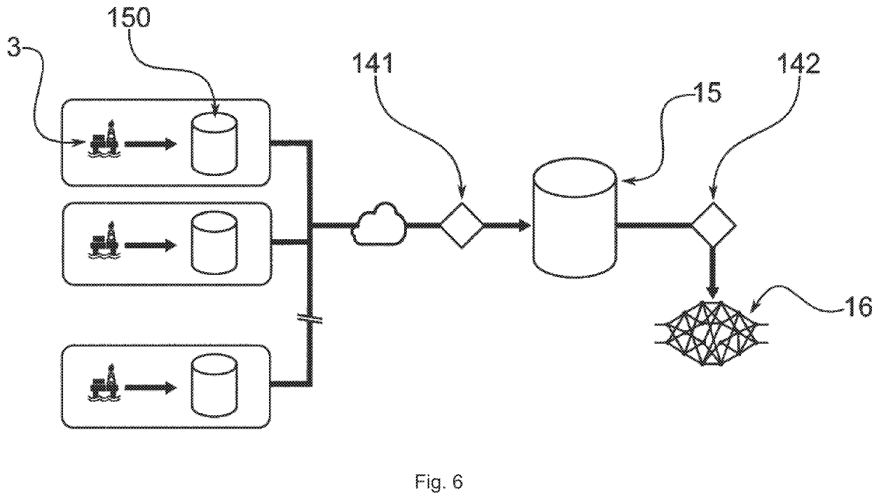

FIGS. 5 and 6 illustrate the process of collecting data and training the model 16. In FIG. 5, the equipment 2 pending its maintenance 6 to be performed is considered, associated with its logs 9, 11, 12, as well as a given instant (t) in the course of the period 5.

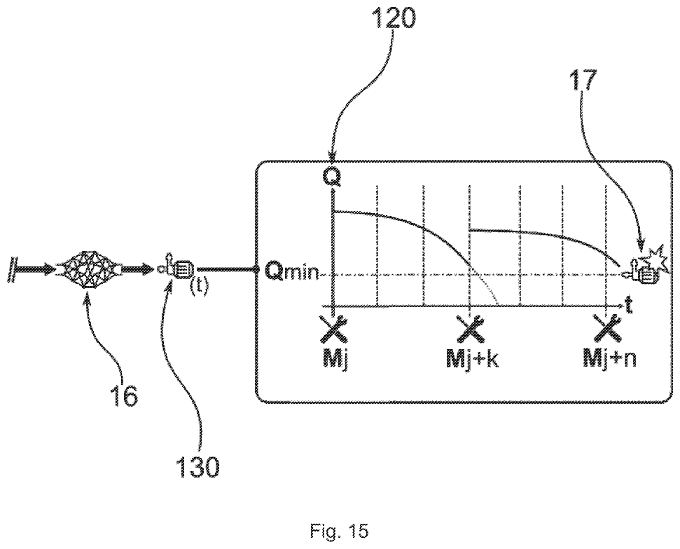

FIG. 5 shows the three terms of the triplet 140, linked by the correlation 14, namely the manufacturing and maintenance set 95, the usage set 115 of said equipment as well as the status 13 of said equipment at said instant (t), with:
the manufacturing and maintenance set 95 comprising the manufacturing and maintenance decisions from rank 0 to rank k of the last maintenance preceding said instant (t);
the usage set 115 comprising the usage sub-logs 111 in the course of the period 5 up to said instant (t);
the status 13 at said instant (t) of the equipment 2. FIG. 15 also shows the extraction and processing of the data associated with said equipment 2, especially showing:
the extraction of the data associated with the manufacturing and maintenance set 95, with the usage set 115 and with the status 13 at said instant (t);
the constitution of the triplet 140 (set 95; set 115; status 13 at said instant (t)) as can be seen in FIG. 5;
the formation of as many similar triplets as there are instants (t) logged in the course of the period 5;
the injection of said triplets into a raw dataset 150, as can be seen in FIG. 5;
the constitution of said raw dataset 150 for each of the items of equipment of the same type as said equipment 2, within the facility 3.

FIG. 6 schematically depicts:
recovering with transmission, with a view to merging them, raw datasets 150 extracted from several facilities 3 operating the equipment of the same series as the item of equipment 2, followed by conversions 141 applied to these data, to constitute a dataset 15;
presenting said dataset 15 as the input of a machine-learning project 142 and training, on the basis of said dataset 15, a virtual model 16 modeling the correlation 14. By thus modeling the behavior of the equipment 2 (or the behavior of the equipment of the series), the invention correlates, on the scale of the series, the behavior observed (namely the status 13) of each item of equipment 2 with the manufacturing and maintenance log 9 and with the usage log 11 of said equipment 2. The invention is thus a form of using the feedback, which draws its superior nature from the relevance, in functional terms, of the modeled correlation 14, especially since it is specific to the physical phenomena which each item of equipment 2 of the series hosts.

According to one embodiment, the training of the model 16 belongs to the field of artificial intelligence and can be machine learning. In other words, the invention foresees the usage of computer technology involving artificial intelligence, especially of the field of machine learning, which is based on mathematical and statistical approaches to give computers the ability to learn from data, that is to say to improve their performance in solving tasks without being explicitly programmed for each of them.

In particular, the supervision system 1 comprises a model 16 foreseen as virtual, resulting from such learning. Further, the training of the model 16 may involve machine learning of any type, that is to say, in a non-limiting manner, supervised, semi-supervised, unsupervised, reinforcement, or even by transfer. Further, machine learning can implement training methods of any category, said methods being able to be combined, that is to say, in a non-limiting manner: neural networks (including deep learning methods), the k-nearest neighbors method (“KNN”), genetic algorithms, genetic programming, or other methods such as, especially Bayesian networks, support vector machines (SVM), Q-learning, decision trees, statistical methods, logistic regression, linear discriminant analysis.

Preferentially, the training of the model 16 involves a supervised, regression-based and deterministic machine-learning problem (the model 16 preferentially determining a vector of quantitative and continuous data, from a set 15 of labeled data, a data vector that the invention has chosen to integrate into the projected status 130 of the equipment 2).

According to other embodiments, the model 16 may be of any type.

The invention envisages taking into account the new manufacturing, maintenance, usage and status data generated since the first training of the model 16, in the context of the machine-learning project 142, and updating said virtual model 16. To do this, according to one embodiment, the preceding operations are repeated periodically:
the recovery of new data from at least one manufacturer, maintenance technician and/or operator is repeated. Preferably, the new data relating to all the equipment 2 of the series are recovered from the set of operators implementing the equipment of the series;
the extraction and the conversion 141 of said new data are then performed in order to obtain a completed dataset 15, followed by updating the training of said model 16 on the basis of said completed dataset 15.

It will be noted that this update is performed periodically, the periodicity being determined by the designer, manufacturer, maintenance technician and operators, as a function of criteria deemed most relevant by the latter or from the “data science” point of view.

For example, a periodicity criterion may correspond to a ratio of 10% of the duration over which the raw dataset 150 was compiled in the context of the first training. If the data were compiled over ten years, then the periodicity for updating the virtual model 16 may correspond to twelve months.

The invention thus makes it possible to use the systematic feedback in a continuous or quasi-continuous manner.

According to the invention, once the correlation 14 is determined and the training of the model 16 is performed, the invention applies said model 16 for the equipment 2.

To do this, advantageously, during the maintenance 6 to be performed of said equipment 2, values are submitted to said model 16. These values correspond to at least one of the tasks 90 of the manufacturing and maintenance log 9 and to at least one of the usage conditions 110 of the usage log 11. Furthermore, the values correspond to at least one of the tasks 90 of the maintenance 6 to be performed and to said projected usage conditions 110 of the scenario 8.

Indeed, the model 16 has learned to correlate the status 13 of the equipment 2 at one instant with the manufacturing and maintenance set 95 (i.e., up to the last prior maintenance 10 preceding said instant), as well as with the usage set 115 up to said instant.

The model 16 is thus able to correlate the projected status 130 of the equipment 2 at one instant with the modified manufacturing and maintenance log 9 of the tasks 90 of the maintenance 6 to be performed, as well as with the usage log 11 up to said instant followed by the partial scenario 80.

In the application of said model 16, the following input data are thus submitted to said model 16:
an overall manufacturing and maintenance log consisting of the manufacturing and maintenance log 9 of the item of equipment 2 (up to the last prior maintenance 10 preceding the maintenance 6 to be performed), modified with the tasks 90 relating to the maintenance decision considered for the maintenance 6 to be performed;
an overall usage log consisting of the usage log 11 of the equipment 2 (up to the day before the maintenance 6 to be performed), followed by the partial scenario 80 in question (from the beginning of the projected period of operation 70 up to the instant considered in the course of said projected period 70).

Thus, the invention uses said model 16 as a simulator customized to the item of equipment 2.

Indeed, the model 16 makes it possible to simulate the projected status 130 of the equipment 2 at one instant for a given maintenance decision regarding the tasks 90 of the maintenance 6 to be performed on said equipment 2, as well as for the usage of said equipment 2 that follows in the context of the scenario 8 up to said instant. Furthermore, this simulation is customized to said equipment 2, since the manufacturing and maintenance log 9 up to the day before the maintenance 6 to be performed and the usage log 11 up to the day before the maintenance 6 to be performed, which were taken into account for performing this simulation, are specific to the equipment 2, namely specific to the equipment 2 in question.

As can be seen in FIG. 1, the application of the supervision system 1 to the equipment 2 pending maintenance 6 to be performed (of rank j), makes it possible to determine a projected status 130 of said equipment 2 for a future instant corresponding to the day before the projected maintenance 7 (of rank j+1), taking into account the data relating to said equipment 2:
the manufacturing and maintenance log 9 of said equipment and the usage log 11;
and the tasks 90 of a maintenance decision in respect of the maintenance 6 to be performed and a usage scenario 8.

FIG. 1 in particular depicts the model 16 receiving, as input, the aforementioned data and generating, as output, the projected status 130 of the equipment 2 at the end of the projected period 70.

Further, once these values have been submitted, said model 16 generates a projected status 130 of said equipment 2 subsequent to said maintenance 6 to be performed.

In other words, from the data submitted as input, the model 16 is able to predict a projected status 130 of the item of equipment 2 for the instant considered, that is to say, a value for the instant considered for each of the material indicators 120 of this projected status 130. Said projected status 130 is then compared to a minimal status 17 identified as being required for the operation of said equipment 2.

In other words, for each of the material indicators 120 of this projected status 130, the value predicted by the model 16 is compared to the minimal value required for the operation of the equipment 2—for example the minimal value of a performance of said equipment 2 (or according to the circumstances, with the maximal value required for the operation of the equipment 2—for example the maximal value of a wear of said equipment 2).

If the projected status 130 thus simulated for the instant considered complies with the operating criterion (that is to say, if the value predicted by the model 16 of each material indicator 120 of the projected status 130 is greater (or lower) than the minimal (or maximal) value required for the operation of the equipment 2), then the predicted projected status 130 corresponds to a correct operational status of the equipment 2.

For example, the case of an item of equipment 2 such as a pump is considered, the status 13 of which can be considered at one instant (t) to be characterized by means of the two material indicators 120, namely the flow rate (Q(t)) and the delivery pressure (Pref(t)), with Qₘᵢₙ and Prefₘᵢₙ, respectively, for minimal values required for the operation of the pump.

The minimal status 17 of the pump is therefore the set of values [Qₘᵢₙ, Prefₘᵢₙ]. The operating criterion of the pump at the instant (t) is therefore that the projected status 130 is greater than the minimal status 17, that is to say that the flow rate Q(t) and the delivery pressure Pref(t) comply with the two conditions Q(t)>Qₘᵢₙ and Pref(t)>Prefₘᵢₙ.

To identify whether the projected status 130 of the pump, as predicted for the instant considered by the model 16, corresponds to a correct operational status of the pump, the status 130 is then compared to the minimal status 17, that is to say the predicted values of the flow rate Q(t) and delivery pressure Pref(t) material indicators 120 for the instant are compared to their respective minimal values Qₘᵢₙ and Prefₘᵢₙ.

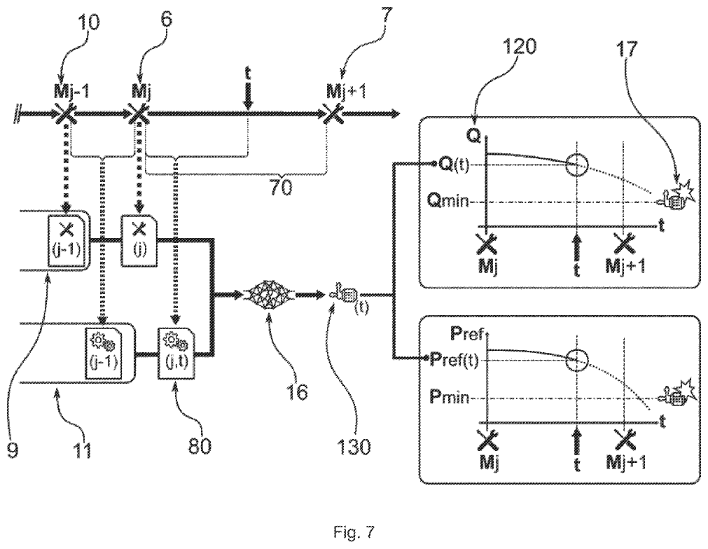

FIG. 7 illustrates, in the case of this example, the prediction of this projected status 130 as well as the comparison with the minimal status 17.

FIG. 7 repeats the previous example of the case of an item of equipment 2 such as a pump, the status 13 of which, at an instant (t), can be characterized by means of two material indicators 120, namely the flow rate (Q(t)) and the delivery pressure (Pref(t)), with Qₘᵢₙ and Prefₘᵢₙ, respectively, as values of the material indicators 120 of minimal status 17, minimal values which are required for the operation of the pump.

FIG. 7 shows the evolution of the projected status 130 of the pump (i.e., the successive values of the material indicators 120 Q and Pref), calculated by the model 16, in the course of the projected period 70.

Since the curves of the projected status 130 are decreasing over time due to aging, FIG. 7 also illustrates the comparison of the status 130 thus predicted at an instant (t) with the minimal status 17: in order to identify whether the projected status 130 of the pump corresponds to a correct operational status of the pump, the projected status 130 is then compared to the minimal status 17, that is to say the predicted values of the flow rate (Q(t)) and delivery pressure (Pref(t)) material indicators 120 for said instant are compared to their respective minimal values Qₘᵢₙ and Prefₘᵢₙ.

According to one embodiment, it is determined whether, for a given maintenance decision (decision concerning the tasks 90 to be executed on the item of equipment 2) in respect of the maintenance 6 to be performed, followed by a given scenario 8, the maintenance decision in question will be sufficient, namely whether it will give the equipment 2 the sufficient potential for zero failures during operation, in the context of said current scenario 8 and up to the end of the projected period 70, or up to the day before the projected maintenance 7. To do this, according to one embodiment, at least one variation of at least one of the values of the tasks 90 of the maintenance 6 to be performed is carried out. Then, when the values are submitted to said model 16, the values of said variation are introduced.

Among all the variations, at least one sufficient decision of the maintenance to be performed is selected, for the projected status 130 of said equipment 2, greater than or equivalent to the minimal status 17, at the time of said projected maintenance 7.

In other words, and in the case where the projected maintenance 7 corresponds to the next maintenance step that follows the maintenance 6 to be performed, a set of possible maintenance decisions (concerning the tasks 90) are considered for the maintenance 6 to be performed and it is intended to determine, among the latter, the sufficient maintenance decisions. For example, the case of an item of equipment 2 such as a pump is considered for which two maintenance tasks 90 are identified as critical:
replacing the pump bearing (with types A and B as possible bearing types);
and replacing the pump impeller (with types A, B and C as possible impeller types).

The possible maintenance decisions for the maintenance 6 to be performed are then the twelve combinations of decisions formed from the following:
the three possible decisions regarding the bearing: do nothing (leave the bearing in place) or replace the bearing with a type-A or type-B bearing;
the four possible decisions regarding the impeller: do nothing (leave the impeller in place) or replace the impeller with a type-A. type-B or type-C impeller.

Among these twelve possible maintenance decisions, it is intended to determine the sufficient maintenance decisions. Furthermore, if, among these possible decisions for the maintenance 6 to be performed, a maintenance decision is characterized by the vector [0;A] (i.e., bearing not replaced and impeller replaced with a type-A impeller) and another maintenance decision is characterized by the vector [0;0] (i.e., bearing not replaced and impeller not replaced), these two maintenance decisions for the maintenance 6 to be performed vary with regard to the impeller (in extenso, the variation of the values of the tasks 90 of the maintenance 6 to be performed relates to the variation of the “replacement” and “non-replacement” values of the impeller). For each of the possible maintenance decisions for the maintenance 6 to be performed, the aforementioned customized simulation is implemented by the model 16, in order to determine the projected status 130 of the equipment 2 at the end of the projected period 70, that is to say, on the day before the projected maintenance 7 (taking into account the usage of the equipment 2 following the maintenance 6 to be performed in the context of the scenario 8 up to the instant corresponding to the day before the projected maintenance 7, and taking into account the manufacturing and maintenance log 9 of the equipment 2 up to the day before the maintenance 6 to be performed, and taking into account the usage log 11 of the equipment 2 up to the day before the maintenance 6 to be performed). If, compared to the minimal status 17 required for the operation of the equipment 2, the projected status 130 (thus simulated by the model 16 for the instant corresponding to the end of the projected period 70), complies with the operating criterion of the equipment 2, the maintenance decision is considered to be sufficient (referred to as “sufficient maintenance decision”) to give the equipment 2 the sufficient potential for zero failures during operation in the context of the scenario 8 up to the end of the projected period 70.

For example, the case of an item of equipment 2 such as a pump is considered, the status 13 of which can be characterized at one instant by means of the two material indicators 120 of the status 13, namely the flow rate (Q) and the delivery pressure (Pref), respectively with (Qₘᵢₙ) and (Prefₘᵢₙ) for minimal values required for the operation of the pump. The maintenance decision is considered to be sufficient if it allows a projected status 130 (for the instant corresponding to the end of the projected period 70) complying with the operating criterion of the pump, namely the two conditions concerning the material indicators 120: (Q>Qₘᵢₙ) and (Pref>Prefₘᵢₙ) for the instant corresponding to the end of the projected period 70. The simulation is repeated for each of the possible maintenance decisions (concerning the tasks 90) for maintenance 6 to be performed. The respective projected statuses 130, thus simulated by the model 16 for the instant corresponding to the end of the projected period 70, thus make it possible to sort the possible maintenance decisions for the maintenance 6 to be performed between the sufficient maintenance decisions and the insufficient decisions.

Thus, among all the variations of at least one of the values of the tasks 90 of the maintenance 6 to be performed, at least one sufficient decision of said maintenance 6 to be performed is selected, for the projected status 130 of said equipment 2 that is greater than or equivalent to the minimal status 17, at the time of said projected maintenance 7.

According to one embodiment, for a given maintenance decision (concerning the tasks 90 of the maintenance 6 to be performed) and for each of the projected usage conditions 110 of the scenario 8 of the equipment 2 over the projected period 70, the possible maximal limit 18 is determined that remains compatible with zero failures of the equipment 2 (i.e., the limit compatible with uninterrupted operation of the equipment 2, without risk of failure) in the context of the scenario 8, in the course of and up to the end of the projected period 70, or up to the day before the next projected maintenance 7 which follows the maintenance 6 to be performed.

To do this and for a given maintenance decision, the value of at least one of the projected usage conditions 110 of the scenario 8 is modified. When said values are submitted to said model 16, the values of said modification as well as the values of said maintenance decision are introduced. A limit is then calculated for at least one of said projected conditions 110 for the projected status 130 of said equipment 2 equivalent to the minimal status 17, at the time of the projected maintenance 7. In other words, the scenario 8 of the equipment 2 over the projected period 70 being characterized by at least one controllable projected usage condition 110, the value of said controllable projected usage condition 110 (“left free”) is left free to vary, and the other possible projected usage conditions 110 (controllable and/or not controllable) are set to their respective value of the scenario 8. The model 16 is then used to solve, by an iterative method and with respect to the controllable projected usage condition 110 left free, the equation in which the projected status 130 of the equipment 2 at the end of the projected period 70 corresponds to the minimal status 17.

For a given maintenance decision (concerning the tasks 90 of the maintenance 6 to be performed) and for the controllable projected usage condition 110 in question, a possible limit is thus determined (preferably a maximal limit 18) which remains compatible with zero failures of the equipment 2 (i.e., a limit compatible with uninterrupted operation of the equipment 2, without risk of failure) up to the end of the projected period 70 (the other projected usage conditions 110 remaining set at their respective value of the scenario 8).

For example, in the case where the facility 3 is a truck and the supervised item of equipment 2 is the engine of said truck, the scenario 8 between the maintenance 6 to be performed and the following next projected maintenance 7 is considered, characterized by the following projected usage conditions 110:
controllable projected usage conditions 110: the average load to be transported (two tons=2 T), the distance to be traveled (one hundred thousand kilometers=100,000 km), the average speed (ninety kilometers per hour=90 km/h);
uncontrollable projected usage conditions 110: the ambient air temperature (twenty degrees Celsius=20° C.), the average gradient of the routes used (five percent=5%).

For this scenario 8, it is intended to determine the value of the maximal limit 18 of the average load to be transported, compatible with zero failures up to the projected maintenance 7 that follows the maintenance 6 to be performed, the other projected usage conditions 110 remaining set at their respective target value of the scenario 8.

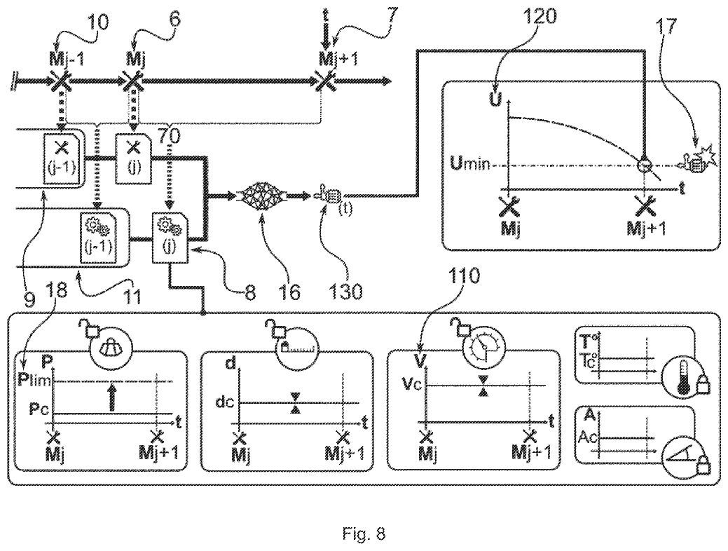

The usage of the model 16 to solve, by the iterative method and with respect to the average load to be transported, the equation in which the projected status 130 of the equipment 2 at the end of the projected period 70 corresponds to the minimal status 17, then gives, by way of example, a maximal limit 18 of 2.5 T (for a target value of the average load to be transported of 2 T in the scenario 8). In FIG. 8, the aforementioned example of the item of equipment 2 such as a truck engine is considered, in which the usage conditions 110 are the load to be transported P, the mileage to be traveled d, the average speed V, the ambient air temperature T° and the average gradient of the routes used A. It is additionally assumed in FIG. 8 that the projected status 130 is defined by the material indicator 120 corresponding to the average compression pressure of the cylinders U, with as minimal value required for the correct operation of the equipment 2 the value Uₘᵢₙ of the minimal status 17. FIG. 8 illustrates the calculation of the maximal limit 18 (Plim) of the controllable usage condition 110 P, for the equipment 2, associated with its fixed logs 9 and 11, for a given maintenance decision in respect of the maintenance 6 to be performed, for a usage scenario 8 over the projected period 70, defined by the respective target average values (Pc, dc, Vc, T°c, Ac) of the controllable (P, d, V) and uncontrollable (T°, A) usage conditions 110 (Pc=2 T; dc=100,000 km; Vc=90 km/h; T°c=20° C.; Ac=5%, as recalled in the aforementioned example).

For the other four usage conditions 110 (d,V,T°,A) set at their respective target average value (dc=100,000 km, Vc=90 km/h, T°c=20° C., Ac=5%) of the scenario 8, the maximal limit 18 (in the example, determined as Plim=2.5 T) of the controllable usage condition 110 (P) is determined by virtue of the model 16 and iteratively.

For this maximal limit 18 Plim, the projected status 130 at the end of the projected period 70 corresponds to the required minimal status 17, that is to say the material status indicator 120 then corresponds to the required minimal value (U=Uₘᵢₙ).

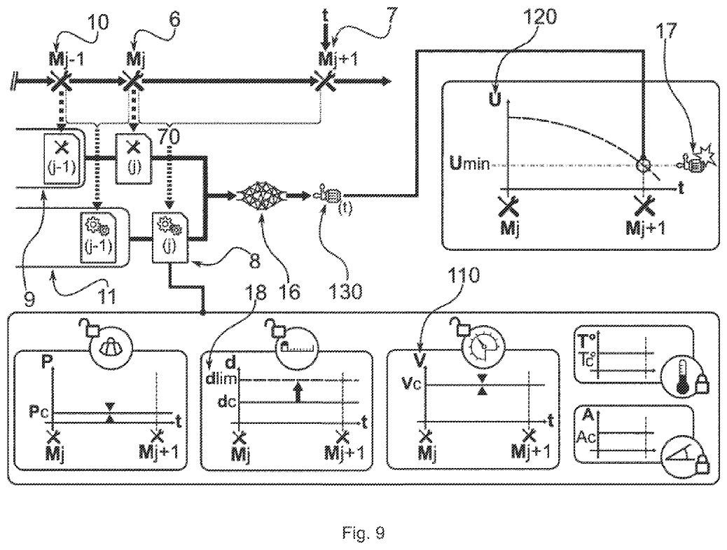

Similarly, FIG. 9 illustrates the calculation of the maximal limit 18 (dlim) of the controllable usage condition 110 d. For the other four usage conditions 110 (P,V,T°,A) set at their respective target average values (Pc=2 T; Vc=90 km/h; T°c=20° C.; Ac=5%) of the scenario 8, the maximal limit 18 is determined (in the example determined as dlim=110,000 km) of the controllable usage condition 110 (d), by virtue of the model 16 and iteratively. For this maximal limit 18 (dlim), the projected status 130 at the end of the projected period 70 corresponds to the required minimal status 17, that is to say the material status indicator 120 then corresponds to the required minimal value (U=Uₘᵢₙ). For each of the other controllable projected usage conditions 110 of the scenario 8, the same is done in order to determine the possible maximal limit 18 thereof which remains compatible with zero failures of the equipment 2 (i.e., the limit compatible with uninterrupted operation of the equipment 2 without risk of failure) in the context of the scenario 8, in the course of and up to the end of the projected period 70, namely up to the day before the next projected maintenance 7 that follows the maintenance 6 to be performed, and this is done for a given maintenance decision (concerning the tasks 90 of the maintenance 6 to be performed). Determined in this way, said maximal limits 18 bound the usage range compatible with zero failures of the equipment 2 in the context of the scenario 8, in the course of and up to the end of the projected period 70, for a given maintenance decision: it is thus known that zero failures of the equipment 2 are possible as long as the equipment 2 is operated, with a given controllable projected usage condition 110 kept lower than or equal to the value of its maximal limit 18 thus determined, the other projected usage conditions 110 remaining lower than or equal to their respective target value of the scenario 8. It is then possible to graphically represent the target values of the projected usage conditions 110 of the scenario 8, as well as the values of the maximal limits 18 calculated previously for each of the controllable projected usage conditions 110, by means of a web-mapping diagram, each axis being assigned to a projected condition 110. Polygons are thus obtained with as many vertices as there are projected conditions 110.

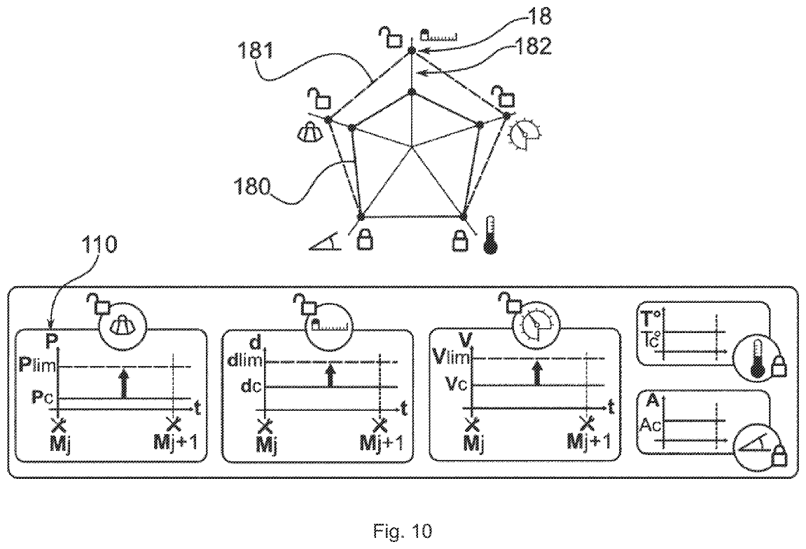

It is thus possible to superimpose a first polygon 180, referred to as “target polygon 180” (representing the target value of each of the projected usage conditions 110 of the scenario 8), with a second polygon 181, referred to as “limit polygon 181” (representing the value of the maximal limit 18 of each of the controllable projected usage conditions 110 and the target value of the scenario 8 for each of the uncontrollable projected usage conditions 110), the target polygon 180 then being framed by the limit polygon 181. FIG. 10 considers the aforementioned example of the item of equipment 2 such as a truck engine for which the usage conditions 110 are the load to be transported P, the mileage to be traveled d, the average speed V, the ambient air temperature T° and the average gradient of the routes used A. It is additionally assumed in FIG. 10 that the projected status 130 is defined by the material status indicator 120 corresponding to the average compression pressure of the cylinders U, with as minimal value required for the correct operation of the equipment 2 the value Uₘᵢₙ of the minimal status 17. FIG. 10 shows the target polygon 180 and limit polygon 181, for the equipment 2, associated with its fixed logs 9 and 11, for a given maintenance decision in respect of the maintenance 6 to be performed, for a usage scenario 8 over the projected period 70, defined by the respective target average values (Pc,dc, Vc,T°c,Ac) of the controllable (P,d,V) and uncontrollable (T°,A) usage conditions 110 (Pc=2 T; dc=100,000 km; Vc=90 km/h; T°c=20° C.; V=5%, as recalled in the aforementioned example).

FIG. 10 shows the “target polygon 180” in solid lines with, along the corresponding axes:
the respective target average values (Pc, dc, Vc) of the controllable projected usage conditions 110 (P, d, V) of the scenario 8, represented by an open padlock;
the respective target average values (T°c, Ac) of the uncontrollable projected usage conditions 110 (T°, A) of the scenario 8, represented by a closed padlock.

FIG. 10 shows the “limit polygon 181” in dotted lines with, along the corresponding axes:
the values (Plim, dlim, Vlim) of the respective maximal limits 18 of the controllable projected usage conditions 110 (P,d,V) of the scenario 8, represented by an open padlock;
the respective target average values (T°c,Ac) of the uncontrollable projected usage conditions 110 (T°,A) of the scenario 8, represented by a closed padlock.

According to one embodiment, the calculation of the maximal limits 18 of the projected usage conditions 110 of the scenario 8 is repeated for each of the maintenance decisions determined as being sufficient, (i.e., the maintenance decisions, concerning the tasks 90 to be performed on the equipment 2 during the maintenance 6 to be performed, which will give the equipment 2 the sufficient potential for zero failures during operation, in the context of said scenario 8, in the course of and up to the end of the projected period 70, or up to the day before the projected maintenance 7).

To do this, according to one embodiment, when the values are submitted to said model 16, the selected values of said sufficient maintenance decision are introduced. A maximal limit 18 of a projected usage condition 110 is calculated for this sufficient maintenance decision, for the projected status 130 of said equipment 2 equivalent to the minimal status 17, at the time of the projected maintenance 7.

For each maintenance decision determined as being sufficient for the maintenance 6 to be performed and the scenario 8 considered, when the maximal limits 18 of the controllable projected usage conditions 110 have been calculated, the target usage (i.e., the target value of the projected usage conditions 110 of the scenario 8), in the form of the target polygon 180, and the limit usage (i.e., the value of the maximal limits 18 of the controllable projected usage conditions 110 and the target value of the uncontrollable projected usage conditions 110 of the scenario 8), in the form of the limit polygon 181, are graphically represented, in a similar web-mapping diagram, and this is done by superimposing the two polygons.

According to one embodiment, a margin of usage is determined for at least one of the projected usage conditions 110 of said scenario 8, as being the deviation 182 between the corresponding value and the corresponding maximal limit 18.

Indeed, the invention quantifies, for all the controllable projected usage conditions 110 of the scenario 8, the deviation 182 between their target value and the value of their respective maximal limit 18.

In other words, the representation and the superimposition in the same web-mapping diagram of the target polygon 180 of the scenario 8 and of the limit polygon 181 of the maximal limits 18, make it possible to graphically represent, for each controllable projected usage condition 110, the deviation 182 between the target value and the value of the maximal limit 18 of said controllable projected usage condition 110.

For example, in the aforementioned case of the truck engine, the deviation 182 between the target value and the value of the maximal limit 18 is thus graphically represented, for each controllable projected usage condition 110:
for the average load to be transported: the deviation 182 between the target value 2 T and the value of the maximal limit 18 2.5 T;
for the distance to be traveled: the deviation 182 between the target value 100,000 km and the value of the maximal limit 18 110,000 km;
for the average speed: the deviation 182 between the target value 90 km/h and the value of the maximal limit 18 100 km/h.

FIG. 10 shows, for each controllable projected usage condition 110, the deviation 182 between the target value and the value of the maximal limit 18 of said controllable projected usage condition 110. Preferentially and in order to compare comparable deviations 182, the axes of the web-mapping diagram, on which the target polygon 180 of the scenario 8 and the limit polygon 181 of the maximal limits 18 are shown and superimposed, are normalized. In other words, for each controllable projected usage condition 110, the target value as well as the value of its maximal limit 18 are represented on a scale, wherein each value is normalized (i.e., represented by the ratio between said value and the target value).

For example, in the aforementioned case of the truck engine and on a web-mapping diagram in which the axes are normalized, the deviations 182 between the target value and the value of the maximal limit 18 for each controllable projected usage condition 110 can thus be graphically shown:
for the average load to be transported: the target value 2 T is represented by the ratio 1 (2 T/2 T), while the value of the maximal limit 18 is represented by the ratio 1.25 (2.5 T/2 T), that is to say a deviation of 25% between the two values;
for the distance to be traveled: the target value is represented by the ratio 1 (100,000 km/100,000 km), while the value of the maximal limit 18 is represented by the ratio 1.1 (110,000 km/100,000 km), that is to say a deviation of 10% between the two values;
for the average speed: the target value is represented by the ratio 1 ((90 km/h)/(90 km/h)), while the value of the maximal limit 18 is represented by the ratio 1.11 ((100 km/h)/(90 km/h)), that is to say a deviation of 11% between the two values. Thus normalized, these deviations 182 between target value and value of the maximal limit 18 lend themselves to a comparison with one another: they make it possible to identify the controllable projected usage conditions 110 for which the deviation 182 between the target value and the value of the maximal limit 18 is significant or acceptable, as well as the controllable projected conditions 110 for which the deviation 182 is not, which amounts to identifying the projected usage conditions 110 that tolerate a low or high margin before failure, which is acceptable or not.

For example, in the aforementioned case of the truck engine, the deviation 182 between the target value and the value of the maximal limit 18 is much greater for the average load to be transported (25%) than for the mileage to be traveled and the average speed (10% and 11%, respectively). Therefore, the average load to be transported tolerates a larger deviation 182 with respect to its target value (without however calling into question the zero failures), than the mileage to be traveled and the average speed. In other words, there is greater usage confidence before failure for the average load than for the mileage to be traveled and the average speed, in order to benefit from zero failures up to the end of the projected period 70. The operator should therefore pay much more attention, during the projected period 70, to observing the target values of the scenario 8 for the mileage to be traveled and the average speed, than for the average load transported. The invention therefore defines the margin of usage before failure (MUBF) as being the average of the normalized deviations 182 between target value and value of the maximal limit 18 for each controllable projected usage condition 110, or else the average deviation between the target polygon 180 of the scenario 8 and the limit polygon 181 of the maximal limits 18.

In the aforementioned example, the margin of usage before failure (MUBF), averaging the three normalized deviations 182, 25%, 10% and 11%, is approximately 15%. Thus, for a maintenance decision determined as being sufficient for the maintenance 6 to be performed and for a scenario 8, the maximal limits 18 of the controllable projected conditions 110 having been calculated, the suitability of the maintenance decision (concerning the tasks 90 of the maintenance 6 foreseen to be performed) is preferentially quantified in said scenario 8, as well as in the complete log of the equipment 2, by means of the margin of usage before failure (MUBF) indicator associated with said maintenance decision.

For example, the case of an item of equipment 2 such as a truck engine is considered, for which seven sufficient maintenance decisions have been identified in respect of the maintenance 6 to be performed, and for each of which the margin (MUBF) has been calculated, these decisions being:
a first decision (D1) that replaces the diesel filter and makes it possible to obtain an MUBF of 3%;
a second decision (D2) that replaces the injectors and makes it possible to obtain an MUBF of 7%;
the third decision (D3) that replaces injectors and diesel filter and makes it possible to obtain an MUBF of 9%;
a fourth decision (D4) that replaces the injection pump and makes it possible to obtain an MUBF of 11%;
a fifth decision (D5) that replaces injection pump and diesel filter and makes it possible to obtain an MUBF of 13%;
a sixth decision (D6) that replaces injection pump and injectors and makes it possible to obtain an MUBF of 20%;
a seventh decision (D7) that replaces everything (injection pump, injectors and diesel filter) and makes it possible to obtain an MUBF of 25%.

For the equipment 2 and its logs 9, 11, it is noted that the decision D7 proves to be more suited to the scenario 8 than the other decisions, especially the decision D1. Indeed, the decision D1 makes it possible to obtain an MUBF of 3%: to benefit from zero failures up to the end of the projected period 70, an average value of the deviations 182 of 3% for a projected usage condition 110 should be respected with respect to the target value of the scenario 8.

The decision D7, for its part, allows an MUBF of 25%: to benefit from zero failures up to the end of the projected period 70, an average value of the deviations 182 much greater than 25% for a projected usage condition 110 should be respected with respect to the target value of the scenario 8.

The margin of usage (MUBF) thus makes it possible to quantify the suitability of each maintenance decision for the same projected usage scenario 8.

According to one embodiment, once the margin of usage is obtained, an optimal maintenance decision is selected from among the sufficient maintenance decisions, as being the sufficient decision that makes it possible to obtain an acceptable margin of usage or as being the sufficient decision that makes it possible to obtain at least one of said acceptable deviations 182. In other words, for each of the decisions identified as being sufficient for the maintenance 6 to be performed and for the scenario 8 in question, the maximal limits 18 of the controllable projected usage conditions 110 having been calculated, the suitability of the sufficient maintenance decision (concerning the tasks 90 for the maintenance 6 foreseen to be performed) for the scenario 8 that was quantified by means of the margin of usage before failure (MUBF), the invention preferentially selects the optimal maintenance decision as being the decision that allows the intended margin of usage. The optimal decision as regards the volume of the tasks 90 for the maintenance 6 to be performed is thus preferentially determined. In short, this optimal decision is customized to the complete log of the item of equipment 2, is suited to the scenario 8 (to allow zero failures up to the end of the projected period 70 as well as the intended margin of usage before failure).

For example, the aforementioned case of the truck engine is considered, for which the seven sufficient maintenance decisions have been identified (from D1 to D7) in respect of the maintenance 6 to be performed, and for each of which the margin (MUBF) has been calculated.

The operator can consider that a deviation 182 of 10% between the target value of the scenario 8 and the value of the maximal limit 18 is sufficient:
for the load to be transported (i.e., the operator estimates that the average load to be transported between the maintenance 6 to be performed and the next projected maintenance 7 will not exceed the target of 2 T, by more than 10%);
for the mileage to be traveled up to the next maintenance (i.e., the operator estimates that the mileage to be traveled between the maintenance 6 to be performed and the next projected maintenance 7 will not exceed the target of 100,000 kilometers, by more than 10%);
for the average speed (i.e., the operator estimates that the average speed between the maintenance 6 to be performed and the next projected maintenance 7 will not exceed the target of 90 km/h, by more than 10%).

The sufficient maintenance decision in respect of the maintenance 6 to be performed, associated with a margin (MUBF) above 10% and minimizing maintenance constraints is therefore the decision D4, which has a margin (MUBF) of 11%. In particular, the decisions D5, D6 and D7 also appear to make it possible to allow a margin (MUBF) greater than 10% but, with regard to the intention of the operator, would involve unnecessary overmaintenance, with higher maintenance constraints. For the operator, the optimal maintenance decision in respect of the maintenance 6 to be performed is therefore the decision D4 (i.e. the one that comprises replacing the injection pump).

The invention also envisages selecting the optimal maintenance decision to be applied during the maintenance 6 to be performed, as being the decision that allows the intended deviation 182 between the target value of the scenario 8 and the value of the maximal limit 18, and does so for one of the projected usage conditions 110.

For example, the aforementioned case of the truck engine is considered, in which the seven sufficient maintenance decisions (D1 to D7) have been identified in respect of the maintenance 6 to be performed, and wherein the operator:
estimates that the mileage traveled the day before the next projected maintenance 7 cannot exceed the target of 100,000 kilometers of the scenario 8;
estimates that the average speed the day before the next projected maintenance 7 cannot exceed the target of 90 km/h of the scenario 8;
intends a deviation 182 of at least 10% between the target value (2 T) and the value of the maximal limit 18 concerning only the average load to be transported.

In this example, and for each of the seven sufficient maintenance decisions, the deviation 182 for the load to be transported between the target value in the scenario 8 (2 T) and the value of the maximal limit 18 calculated by the simulation of the model 16 is then considered:
the decision D1 allows a deviation 182 of 5% for the load to be transported;
the decision D2 allows a deviation 182 of 11% for the load to be transported;
the decision D3 allows a deviation 182 of 15% for the load to be transported;
the decision D4 allows a deviation 182 of 18% for the load to be transported;
the decision D5 allows a deviation 182 of 21% for the load to be transported;
the decision D6 allows a deviation 182 of 33% for the load to be transported;
the decision D7 allows a deviation 182 of 41% for the load to be transported.

In view of the assumptions and the intention of the operator, the optimal maintenance decision in respect of the maintenance 6 to be performed is, in this case, no longer the decision D4, but the decision D2 (with a deviation 182 of 11% between target value and value of the maximal limit 18 concerning the load to be transported). In particular, the decisions D3 to D7 also appear to lead to the deviation 182 of more than 10% but, with regard to the intention of the operator, would involve unnecessary overmaintenance, with higher maintenance constraints. For the operator, the optimal maintenance decision in respect of the maintenance 6 to be performed is therefore in this case the decision D2 (i.e., the one that comprises replacing the injectors).

The invention can also select the optimal maintenance decision to be applied during the maintenance 6 to be performed, as being the decision that allows the intended average of the deviations between the target value of the scenario 8 and the value of the maximal limit 18, and does so for an intended part of the projected usage conditions 110.

For example, the aforementioned case of the truck engine is considered, in which the seven sufficient maintenance decisions (D1 to D7) have been identified in respect of the maintenance 6 to be performed,
wherein the operator estimates that the average speed the day before the next maintenance cannot exceed the target of 90 km/h, and
wherein the operator intends an average value of the deviations 182 of 10% (between target value of the scenario 8 and value of the maximal limit 18) concerning the load to be transported and the mileage to be traveled.

In this example, and for each of the sufficient maintenance decisions, the average of the deviations 182 between the target value of the scenario 8 and the maximal limit 18 is then considered for the two projected usage conditions 110—the load to be transported and the mileage to be traveled—with the maximal limits 18 calculated by the simulation allowed by the model 16.

It is additionally assumed in the example that:
the decision D1 allows deviations 182 of 5% and 2%, respectively, for the load to be transported and the mileage to be traveled, or an average deviation of 3%;
the decision D2 allows deviations 182 of 11% and 5%, or an average deviation of 8%;
the decision D3 allows deviations 182 of 15% and 6%, or an average deviation of 10%;
the decision D4 allows deviations 182 of 18% and 7%, or an average deviation of 13%;
the decision D5 allows deviations 182 of 21% and 8%, or an average deviation of 15%;
the decision D6 allows deviations 182 of 33% and 13%, or an average deviation of 23%;
the decision D7 allows deviations 182 of 41% and 16%, that is to say an average deviation of 29%.

In view of the assumptions and the intention of the operator, the maintenance decision in respect of the maintenance 6 to be performed, is in this case no longer the decision D2 or the decision D4, but the decision D3, with an average deviation of 10%. In particular, the decisions D4 to D7 also appear to allow an average deviation greater than 10% but, with regard to the intention of the operator, appear to involve unnecessary overmaintenance, with higher maintenance constraints. For the operator, the optimal maintenance decision in respect of the maintenance 6 to be performed is therefore in this case the decision D3 (i.e., the one that comprises replacing the injectors and the diesel filter).

Thus, for the equipment 2 that has operated up to the maintenance 6 to be performed and for the scenario 8 to be executed after said maintenance 6 to be performed, the simulation allowed by the model 16 makes it possible to determine:
among a set of sufficient maintenance decisions, the optimal maintenance decision: this decision regarding the nature of the tasks 90 for the maintenance 6 to be performed is customized to the complete log of the item of equipment 2, suited to the scenario 8 to allow zero failures up to the end of the projected period 70 and allows the intended margin of usage before failure (MUBF);
the associated limit usage, namely the maximal possible usage (compatible with zero failures up to the next projected maintenance 7 date following the maintenance 6 to be performed), bounded by the maximal limits 18 of the controllable projected usage conditions 110 (said maximal limits 18 being associated with the optimal maintenance decision).

For example, the aforementioned case of the truck engine is considered, for which the seven sufficient maintenance decisions (D1 to D7) have been identified in respect of the maintenance 6 to be performed, and wherein the operator intends an average margin of usage before failure (MUBF) of 10% for the set of controllable projected usage conditions 110 (average load to be transported, mileage to be traveled up to the next maintenance and average speed).

In this example (and taking into account the manufacturing and maintenance log 9 and the usage log 11 of the truck engine, as well as the scenario 8 in the course of the projected period 70), among the sufficient maintenance decisions in respect of the maintenance 6 to be performed, the optimal maintenance decision is the decision D4 (i.e., the one that comprises replacing the injection pump).

The limit usage to be observed in the course of the projected period 70 in order to benefit from zero failures of the engine up to the end of said projected period 70 is the limit usage associated with this optimal maintenance decision (i.e., the one bounded by the maximal limits 18 which have been calculated for the projected usage conditions 110 and for said maintenance decision D4: 2.3 T with a deviation 182 of 18% with respect to the target value of 2 T, 107,000 km with a deviation 182 of 7% with respect to the target value of 100,000 km, 97 km/h with a deviation 182 of 8% with respect to the target value of 90 km/h).

In other words, taking into account the mode for calculating the maximal limits 18, it is possible to ensure zero failures of the truck engine up to the end of the projected period 70 as long as the engine is operated, with a given controllable condition 110 that is kept lower than or equal to the value of its maximal limit 18 thus determined, the other conditions 110 being kept lower than or equal to their respective target value of the scenario 8.

The construction of the limit polygon 181, from the maximal limits 18 of the projected usage conditions 110, in order to quantify the average deviation thereof with the target polygon 180 of the scenario 8 (i.e., the margin of usage before failure (MUBF)) is a conceptual tool foreseen by the invention.

Indeed, for the same target scenario 8 and in each case of sufficient maintenance decision 6 to be performed, the limit polygon 181 and the margin (MUBF), always calculated according to the same methodology, make it possible to assess the suitability of each maintenance decision for the target scenario 8 (taking into account the manufacturing and maintenance log 9 and the usage log 11 of the equipment 2): the limit polygon 181 and the margin (MUBF) thus make it possible to compare the maintenance decisions between them.

Further, the invention foresees deducing all the usage scenarios compatible with zero failures up to the date of the next maintenance.

Indeed, taking into account the mode for calculating the maximal limits 18, the limit polygon 181 and its maximal limits 18 bound the limit usage compatible with zero failures of the equipment 2 up to the end of the projected period 70, in the sense that zero failures are possible as long as the equipment 2 is operated, with a given controllable projected usage condition 110 that is kept lower than or equal to the value of its maximal limit 18, but only if the other projected usage conditions 110 are kept lower than or equal to their respective target value of the scenario 8. In particular, the limit polygon 181 does not make it possible to deduce whether the usage of the equipment 2, with two controllable projected usage conditions 110 that can be brought beyond their respective target value, while observing their respective possible maximal limit 18, remains compatible with the intended zero failures. For example, the aforementioned case of the truck engine is considered, with a target scenario 8, between the maintenance 6 to be performed and the following projected maintenance 7, defined as follows:
controllable projected usage conditions 110: average load to be transported of 2 T, distance to be traveled of 100,000 km, average speed of 90 km/h;
uncontrollable projected usage conditions 110; ambient air temperature of 20° C., average gradient of the routes used of 5%.
   In this example, it is additionally assumed that the maximal limits 18 are for the average load to be transported of 2.5 T, for the distance to be traveled of 110,000 km and for the average speed of 100 km/h.

In this example, as constructed, the limit polygon 181 indicates the following usage scenarios 8 as being compatible with zero failures up to the next projected maintenance 7:
2.5 T transported on average over 100,000 kilometers traveled on average at 90 km/h between the two maintenance operations;
2 T transported on average over 110,000 kilometers traveled on average at 90 km/h between the two maintenance operations;
2 T transported on average over 100,000 kilometers traveled on average at 100 km/h between the two maintenance operations.

Nevertheless, as constructed, the limit polygon 181 does not make it possible, in any way, to tell whether 2.3 T transported on average over 105,000 kilometers, traveled on average at 95 km/h between the two maintenance operations is a usage scenario compatible with the intended zero failures up to the end of the next projected maintenance 7. According to one embodiment, the invention therefore foresees differently determining all the usage scenarios compatible with zero failures up to the date of the next maintenance. To do this, the system 1 comprises a graphic representation in the form of a chart, with at least one curve indicating the maximal limit 18 of a first projected condition 110 as a function of at least a second one of said projected conditions 110. This chart makes it possible to determine the usage scenarios compatible with zero failures for the projected period 70 comprised between the maintenance 6 to be performed and the next projected maintenance 7.

In other words, the invention envisages constructing at least one graphic representation of the nomogram type, by way of example in the form of a set of curves on a chart, hereinafter “chart”, allowing richer information in terms of limit scenarios. For a given scenario 8 (defined by the target values of the controllable and uncontrollable projected usage conditions 110), the constructed chart graphically represents the set of limit usages compatible with zero failures up to the date of the next projected maintenance 7, namely all the n-tuples of the values of the controllable projected usage conditions 110, each n-tuple indicating, for the value of (n−1) controllable projected usage conditions 110, the maximal limit 18 of the nth controllable projected usage condition 110 compatible with zero failures up to the date of the next projected maintenance 7 (the uncontrollable projected usage conditions 110 of the scenario 8 being locked at their respective value). For example, the aforementioned case of the truck engine is considered with, as the scenario 8 between the maintenance 6 to be performed and the next projected maintenance 7 is considered, the scenario defined by the following projected usage conditions 110:
controllable projected usage conditions 110: average load to be transported of 2 T, distance to be traveled of 100,000 km, average speed of 90 km/h;
uncontrollable projected usage conditions 110; ambient air temperature of 20° C., average gradient of the routes used of 5%.

In this case and with a graphic representation of the mileage to be traveled as a function of the average load to be transported, the chart is a set of curves, each associated with a given average speed between the two successive maintenance operations. Each iso-velocity curve is the set of the triplets of the values of the three controllable projected usage conditions 110 (average load to be transported; distance to be traveled, average speed), each triplet defining a limit usage compatible with zero failures up to the date of the projected maintenance 7 (the uncontrollable projected usage conditions 110 of the scenario 8—the ambient air temperature and the average gradient of the routes used—being locked at their respective value of 20° C. and 5%). Thus, the curve associated with the average speed of 95 km/h makes it possible to deduce, for a given value of the average load to be transported (for example 2.3 T), the value of the maximal limit 18 of the distance to be covered (101,000 km in this example) up to the next projected maintenance 7, or thus the maximum possible value compatible with zero failures up to the date of the projected maintenance 7 (the uncontrollable projected usage conditions 110—ambient air temperature and average gradient of the routes used—being locked at their respective values of the target scenario 8 (20° C. and 5%)). To do this, in order to construct the curve associated with a given value of a controllable projected usage condition 110, the invention calculates, by an iterative method and by virtue of the simulation enabled by the model 16, the maximal limit 18 of a controllable projected usage condition 110, to be observed between the maintenance 6 to be performed and the projected maintenance 7, for different values of the rest of the controllable projected usage conditions 110 (with the uncontrollable projected usage conditions 110 still locked at their respective values of the target scenario 8). In the aforementioned example of the truck engine, there are three controllable projected usage conditions 110. The chart represents a set of curves, each being associated with a value of a first controllable projected condition 110 (for example the average speed).

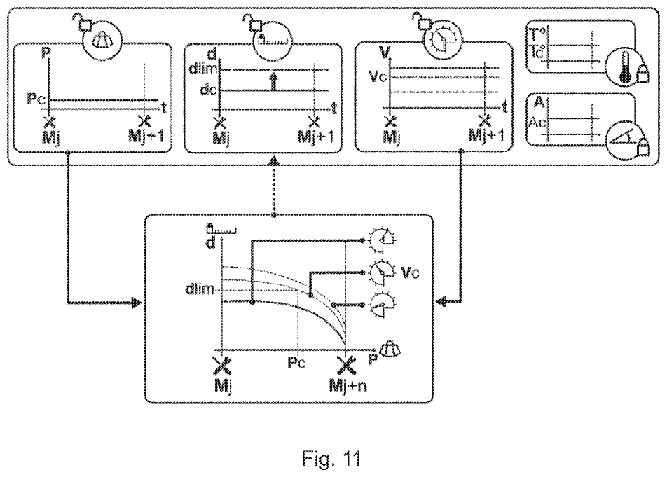

To construct the curve associated with a value of said first controllable projected condition 110 (for example, the average speed of 100 km/h), the maximal limit 18 of a second controllable projected condition 110 (for example, the mileage to be travelled) is calculated by virtue of the simulation by the model 16, for different values of a third projected condition 110 (in this example the average load to be transported), with the uncontrollable projected usage conditions 110 (ambient air temperature and average gradient of the routes used) always locked at their respective value of the target scenario 8 (i.e., in this example 20° C. and 5%, respectively). Thus, for example, the chart indicates the triplet (2.3 T; 101,000 km; 95 km/h) as one of the possible limit usages. In FIG. 11, the aforementioned example of the item of equipment 2 such as a truck engine is considered, in which the usage conditions 110 are the load to be transported P, the mileage to be traveled d, the average speed V, the ambient air temperature T° and the average gradient of the routes used A. It is additionally assumed in FIG. 11 that the projected status 130 is defined by the material status indicator 120 corresponding to the average compression pressure of the cylinders U, with as minimal value required for the correct operation of the equipment 2 the value Uₘᵢₙ of the minimal status 17. FIG. 11 shows an example of usage of such a chart representation, for the equipment 2, associated with its fixed logs 9 and 11, for a given maintenance decision in respect of the maintenance 6 to be performed, for a usage scenario 8 over the projected period 70, defined by the respective target average values (Pc,dc, Vc, T°c,Ac) of the controllable(P,d,V) and uncontrollable (T°, A) usage conditions 110 (Pc=2 T; dc=100,000 km; Vc=90 km/h; T°c=20° C.; Ac=5% as recalled in the aforementioned example).

In FIG. 11, the chart shown is a set of three curves, in a graphic representation of the mileage to be traveled (d) as a function of the average load to be transported (P). The visible curves are associated with three average speeds given between the two successive maintenance operations (90, 95, 100 km/h). For two intended target average values (Pc=2.3 T; Vc=95 km/h) for the controllable usage conditions 110 P and V, the chart, as calculated by the model 16, indicates the value of the maximal limit 18 (dlim=101,000 km) for the last controllable usage condition 110 (d). Thus, the usage scenario, defined by the three intended target average values (Pc=2.3 T, dlim=101,000 km and Vc=95 km/h) for the controllable projected usage conditions 110 and the two target values (T°c=20° C. and Ac=5%) for the uncontrollable projected usage conditions 110 corresponds to a limit scenario compatible with the intended zero failures up to the end of the projected period 70, that is to say, compatible with a projected status 130 of the equipment 2 at the end of the projected period 70 corresponding to the minimal required status 17 for correct operation (U=Umin).

According to one embodiment, once the maintenance 6 has been performed and in the course of the projected period 70, the invention refreshes, at any instant, the projected status 130 of the equipment 2 as it will be at the end of the projected period 70, or the day before the next projected maintenance 7. In other words, at a given instant, in the course of the projected period 70, wherein the scenario 8 of the equipment 2 is being carried out, it is determined whether, taking into account the usage that has actually been made of the equipment 2 from the beginning of the projected period 70, said equipment 2 keeps, at the instant considered, the sufficient potential for zero failures during operation, in the context of the remainder of said scenario 8, in the course of the remainder and up to the end of the projected period 70, or up to the day before the next projected maintenance 7 following the maintenance 6 to be performed. And yet, the invention already foresees selecting, the day before the maintenance 6 to be performed, the optimal maintenance decision among the sufficient maintenance decisions, which allow the projected status 130 at the end of the projected period 70 (and taking into account a scenario 8) compatible with the operation of the equipment 2. The invention however foresees refreshing, at any instant in the course of the projected period 70, the projected status 130 as it will be at the end of the projected period 70, since this refreshing is considered to be potentially necessary.

Indeed, the actual usage of the equipment 2, during the elapsed part of the projected period of operation 70 between the beginning thereof and the instant considered, may have differed with the foreseen usage of the scenario 8.

Furthermore, during the elapsed part of the projected period 70, the equipment 2 may have been subjected to abnormal operating transients, especially to incursions into the domain near destruction, or also to incursions into the intermediate domain between said domain near destruction and the domain of normal operation. And yet, the invention makes the choice for the aging and therefore the future behavior of the equipment to be impacted by the aggregate of these abnormal transients. The invention therefore foresees refreshing, during operation, the projected status 130 as it will be at the end of the projected period 70, with the aggregate of the possible abnormal transients occurring from the beginning of the projected period of operation 70 up to the instant. Similarly, if the invention foresees, the day before the maintenance 6 to be performed, determining the optimal decision for the maintenance 6 to be performed as well as the associated limit usage (namely the maximal possible usage to be observed during operation, after said maintenance 6 to be performed, for zero failures up to the date of the next projected maintenance 7), the invention foresees refreshing this limit usage during operation, as being potentially necessary.

Indeed, the limit usage of the equipment 2 is likely to contract, during operation, due to an actual usage of the equipment 2 (more restrictive for the equipment 2 than the initially foreseen scenario 8), during the elapsed part of the projected period 70, and due to any abnormal operating transients.

By refreshing, during operation, the limit usage compatible with zero failures up to the next projected maintenance 7, the invention foresees allowing the user to thus identify the maximal limits 18 up to which they can push the usage of the equipment without compromising zero failures or in which it must restrict the initially envisaged usage in order to benefit from zero failures. For example, the aforementioned case of the truck engine is considered, wherein the decision D6 for the maintenance 6 to be performed is adopted (namely the replacement of the diesel filter and the injection pump), and wherein, at the end of half of the projected period 70, it turns out that the average load transported correctly observes the target value of 2 T, that the mileage traveled (50,000 km) correctly observes the proportional amount of the target value of the 100,000 km at the end of the projected period 70, but that the average speed was 105 km/h, exceeding the target value of 90 km/h of the scenario 8 and the value of the maximal limit 18 of 100 km/h.

Under these conditions (and in addition to any abnormal transients in the course of the elapsed part of the projected period 70), continuing the operation of the truck in the context of the initial scenario 8 with its target values (2 T, 100,000 km, 90 km/h) will not be compatible with zero failures up to the date of the next target projected maintenance 7: it is therefore advisable to refresh the calculation of the maximal limits 18 of the various projected usage conditions 110, that the operator will have to observe in order to benefit from zero failures up to the end of the projected period 70. To do this, subsequent to said maintenance 6 once it has been performed, updated values are submitted to said model 16. These values correspond to at least one of the tasks 90 of the manufacturing and maintenance log 9, as before, as well as to at least one task 90 of the maintenance 6 performed.

These values also correspond to at least one of the usage conditions 110 of the usage log 11 since said maintenance 6 performed. These values also correspond to the projected usage conditions 110 of the scenario 8.

Therefore, on the basis of these values, said model 16 refreshes the projected status 130 of said equipment 2. Moreover, said projected status 130 is compared to the minimal status 17 identified as being required for the operation of said equipment 2. In short, according to one embodiment, subsequent to said maintenance 6 once it has been performed, values are submitted to said model 16
of at least one of the tasks 90 of the manufacturing and maintenance log 9, of at least one task 90 of the maintenance 6 performed
and of at least one of the usage conditions 110 of the usage log 11 since said maintenance 6 was performed
and of said projected usage conditions 11 of the scenario 8,
said model 16 refreshing the projected status 130 of said equipment 2, said projected status 130 being compared to a minimal status 17 identified as being required for the operation of said equipment 2. In other words, at a given instant in the course of the next projected period 70, the prediction of the projected status 130 of the equipment 2 is refreshed for what it will be at the end of the projected period 70, or on the day before the projected maintenance 7. To do this, and because at the instant considered, the maintenance 6 was performed and the equipment 2 is operational, said model 16 is used as a simulator customized to the equipment 2, by adapting the arguments submitted as input to the model 16, namely:
the manufacturing and maintenance log 9 of the equipment 2;
the tasks 90 executed in respect of the maintenance 6;
the usage log 11 up to the instant considered, followed by the usage in the course of the elapsed part of the projected period of operation 70 up to the instant considered;
the usage of the equipment 2 foreseen in the rest of the scenario 8, from said instant and for the rest of the projected period of operation 70 up to the day before the next projected maintenance 7. This possibility of thus being able to refresh the projected status 130 of the equipment 2, as it will be at the end of the projected period of operation 70 after the future execution of the entire scenario 8 (taking into account the tasks 90 actually executed for the maintenance 6 and taking into account the actual usage of the facility 3 and of the equipment 2 from the beginning of the projected period of operation 70 up to the instant considered) therefore allows the various applications of the model 16 such as the invention foresees on the day before the maintenance 6 to be performed.

In particular, the usage of the model 16 makes it possible to determine, at any time in the course of the projected period 70, whether the continuation of the scenario 8 remains compatible with zero failures up to the end of the projected period 70, by comparing said projected status 130 with the minimal status 17 required for the operation of the equipment 2.

In particular, the usage of the model 16 makes it possible to refresh, at any instant in the course of the projected period 70, the maximal limits 18 of the limit usage compatible with zero failures up to the next projected maintenance 7, the limit polygon 181, the margin of usage before failure (MUBF), as well as the chart of all the limit scenarios: which allows the user to identify the limits to which they can push the usage of the equipment 2 without thereby compromising the zero failures or in which they must restrict the usage initially envisaged in order to benefit from zero failures. The invention refreshes, at a given instant in the course of the projected period 70, the projected status 130 of the equipment 2 as it will be at the end of said projected period 70 and after the execution of the scenario 8. Similarly, the invention refreshes, at a given instant in the course of the projected period 70, the projected status 130 of the equipment 2 as it will be at the end of the projected period 70 and after the execution of a scenario different from the usage scenario 8 initially foreseen, for the period between said instant and the end of the projected period 70.

Among the arguments to be submitted as input to the model 16, instead of submitting the usage of the equipment 2 foreseen in the context of the scenario 8, from said instant and for the rest of the projected period of operation 70 up to the day before the projected maintenance 7, the usage of the equipment 2 in the context of the unforeseen scenario is indeed submitted to the model 16, from said instant and for the rest of the projected period of operation 70 up to the day before the projected maintenance 7. Similarly, the invention refreshes, at a given instant in the course of the projected period 70, and with a view to executing a scenario different from the initially foreseen usage scenario 8, between said instant and the end of the projected period 70, the maximal limits 18 of the limit usage compatible with zero failures up to the next maintenance 7, the limit polygon 181, the margin of usage before failure (MUBF) as well as the chart of all the limit scenarios: which allows the user to identify the limits to which they can push the usage of the equipment without compromising the zero failures or in which they must restrict the usage initially envisaged in order to benefit from zero failures, and to do so with a view to executing of a scenario different from the initially foreseen usage scenario 8. Thus, the invention allows the operator to decide, in the course of the projected period 70, the usage that they can or should make of the equipment 2, to keep this usage compatible with the requirement of zero failures up to the date of the next maintenance, in the context of an initially foreseen scenario 8 as well as in the context of an unforeseen scenario, replacing the initially foreseen scenario 8.

Advantageously, the simulation by the model 16 additionally makes it possible to determine, step by step, the sufficient maintenance decisions for successive projected maintenance operations 7 in the life of the equipment 2, taking into account the target usage (namely the successive scenarios 8) intended by the operator over the short term, as well as in the long term. The system 1 thus makes it possible to determine, at all times, the various possible sufficient maintenance schedules, throughout the entire service life of the equipment 2, for an intended usage profile. To do this, according to one embodiment, at least the following steps are performed.

Firstly, at least said sufficient decision of the maintenance 6 to be performed is assumed to have been performed and the scenario 8 is assumed to have been executed up to the projected maintenance 7 that follows said maintenance 6 to be performed.

Then, at least one variation is made to at least one of the values of the tasks 90 of said projected maintenance 7. When the values are submitted to said model 16, the values of said variation as well as the values of the following scenario 81 foreseen for the following projected period 710 (i.e., the period of operation between said projected maintenance 7 and the following projected maintenance 71) are introduced.

Among all the variations, at least one sufficient decision is selected for said projected maintenance 7, for the projected status 130 of said equipment 2 greater than or equivalent to the minimal status 17, at the time of the projected maintenance 71 following said projected maintenance 7.

Once this sufficient decision has been selected, said steps are repeated for every other following projected maintenance in the life of the equipment. In short, a series of sufficient maintenance decisions is recurrently determined regarding the projected maintenance operations 70 subsequent to the maintenance 6 to be performed, once the sufficient maintenance decisions have been defined in respect of the maintenance 6 to be performed. Indeed, the day before the maintenance 6 to be performed (taking into account a maintenance decision determined as being sufficient for the maintenance 6 to be performed and assumed to have been executed, taking into account the scenario 8 assumed to have been executed), the model 16 makes it possible to determine the sufficient maintenance decisions in respect of the next projected maintenance 7 that will follow the maintenance 6 to be performed. In this sense, the model 16 allows a recurrence, in order to determine step by step, from one projected maintenance operation 7 to the next, the sufficient maintenance decisions.

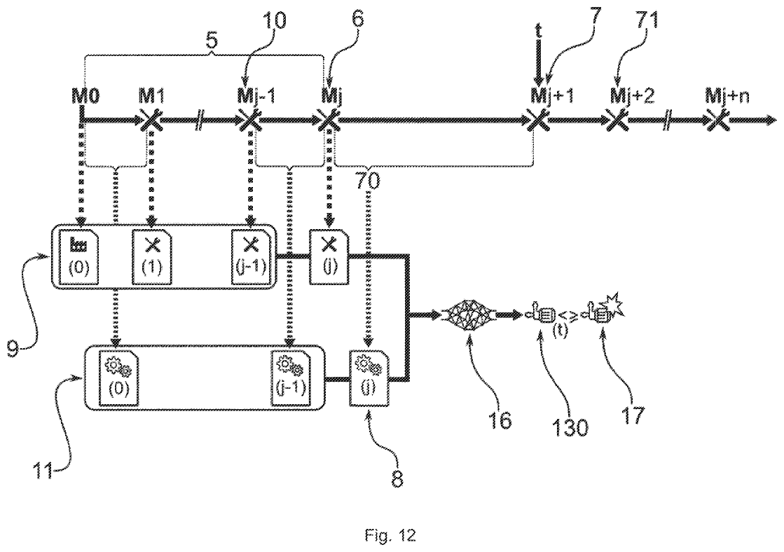

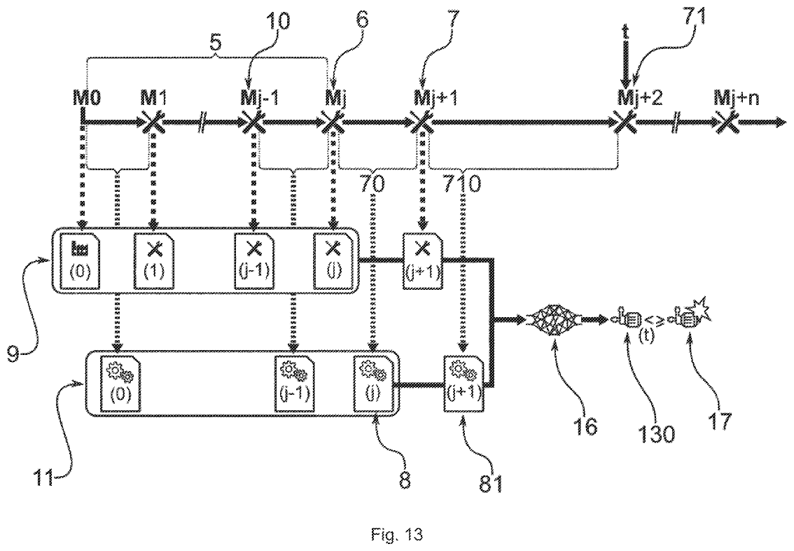

For this reason and similarly to before, for each of the possible maintenance decisions for the projected maintenance 7 that follows the maintenance 6 to be performed, the projected status 130 of the equipment 2 is simulated for what it will be at the end of the following projected period 710, after a subsequent scenario 81, that is to say, the day before the following projected maintenance 71 (i.e., which follows the projected maintenance 7 in question). To do this, and taking into account these assumptions, said model 16 is used as simulator customized to the equipment 2, by adapting the arguments submitted as input to the model 16, namely:
the manufacturing and maintenance log 9 of the equipment 2 (up to the day before the maintenance 6 to be performed), modified with the tasks 90 that are assumed to have been performed in respect of the maintenance 6 to be performed;
the tasks 90 of the possible maintenance decision in question in respect of the projected maintenance 7;
the usage log 11 (up to the day before the maintenance 6 to be performed), followed by the scenario 8 that is assumed to have been executed in the course of the projected period 70;
the following scenario 81 of the equipment 2 (in the course of the following projected period 710 and up to the day before the next projected maintenance 71). If, compared to the minimal status 17 required for the operation of the equipment 2, the projected status 130 of the equipment 2, thus simulated by the model 16 for the instant corresponding to the end of the following projected period 710 (i.e., to the day before the following projected maintenance 71), complies with the operating criterion of the equipment 2, the maintenance decision in respect of the projected maintenance 7 which follows the maintenance 6 to be performed can then be considered to be sufficient to give the equipment 2 the sufficient potential for zero failures during operation in the context of the next scenario 81, in the course of and up to the end of the following projected period 710. The recurrence is thus established. Indeed, on the day before the maintenance 6 to be performed (maintenance of rank j) (taking into account a maintenance decision determined as being sufficient for the maintenance 6 to be performed and assumed to have been executed and taking into account a scenario 8 assumed to have been executed in the course of the following projected period of operation 70), the model 16 has made it possible to determine the sufficient maintenance decisions for the projected maintenance 7 (maintenance of rank j+1), namely the decisions authorizing zero failures for a following scenario 81, in the course of and up to the end of the following projected period 710. Furthermore, the invention makes it possible to determine the sufficient decisions for the maintenance 6 to be performed. The simulation by the model 16 therefore makes it possible to determine, by recurrence, step by step, the sufficient maintenance decision sequences for any projected maintenance 7 and to do so up to the intended projected maintenance 7 rank in the life of the equipment 2 (maintenance of rank j+n). In FIGS. 12 and 13, the equipment 2 associated with its logs 9 and 11 is considered, with (in FIG. 12) a usage scenario 8 in the course of the projected period 70, followed (in FIG. 13) by a following scenario 81 in the course of the following projected period 710. FIGS. 12 and 13 illustrate the step-by-step simulation of the projected statuses 130 of the equipment 2 the day before each projected maintenance operation 7, 71, as well as the determination by recurrence of the sufficient maintenance decisions in respect of said projected maintenance operations 7, 71: the model 16 making it possible to determine the sufficient maintenance decisions in respect of a maintenance operation 6 to be performed (of rank j), the model 16 then makes it possible to determine the sufficient maintenance decisions in respect of the next projected maintenance 7 of rank j+1. Initially, FIG. 12 illustrates that, for a possible maintenance decision in respect of the maintenance 6 to be carried out, the model 16 makes it possible to predict the projected status 130 of the equipment 2 at the end of the projected period 70: in particular, the model 16 therefore makes it possible to determine whether said possible decision is sufficient for allowing the intended zero failures up to the end of the projected period 70 (depending on whether the projected status 130 of the equipment 2 at the end of the projected period 70 is sufficient with regard to the minimal status 17). The model 16 clearly makes it possible to determine the sufficient maintenance decisions, among the possible maintenance decisions, in respect of the maintenance 6 to be performed. In a second step, FIG. 13 illustrates that, for a maintenance decision identified as sufficient in respect of a maintenance operation of rank j (in this case, in respect of the maintenance 6 assumed to have been performed) and for a possible maintenance decision in respect of the following maintenance of rank j+1 (in the case at hand, in respect of the next projected maintenance 7), the model 16 makes it possible to predict the projected status 130 of the equipment 2 at the end of the following projected period 710: the model 16 therefore makes it possible to determine whether this latter possible decision is sufficient for allowing the intended zero failures up to the end of the following projected period 710 (according to whether the projected status 130 of the equipment 2 at the end of the following projected period 710 is sufficient with respect to the minimal status 17). FIG. 13 thus illustrates that, for a maintenance decision identified as sufficient in respect of a maintenance operation of rank j, the model 16 makes it possible to determine the sufficient maintenance decisions, among the possible maintenance decisions, in respect of the following maintenance of rank j+1.

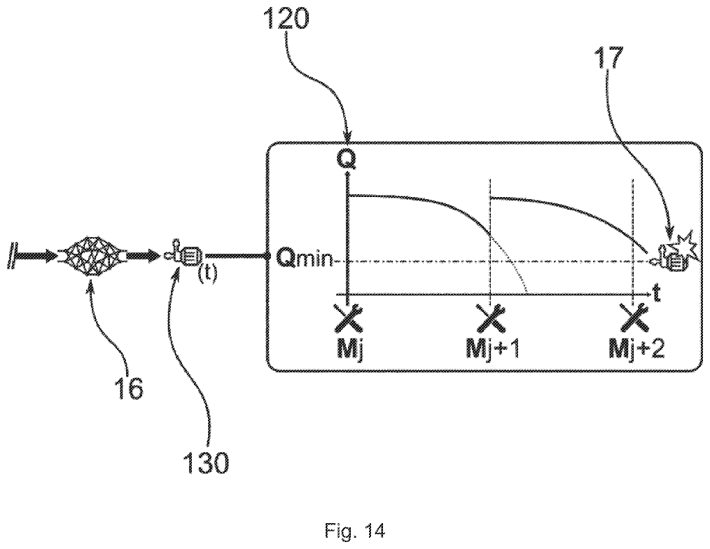

As can be seen in FIGS. 12 and 13, the system 1 thus makes it possible to determine, by recurrence, sufficient maintenance decisions, from one maintenance operation to the other in the life of the equipment 2, namely step by step, from a maintenance operation of rank k to a maintenance operation of rank k+1. In particular, FIGS. 12 and 13 show how the model 16 is used both to determine the projected statuses 130 of the equipment 2 in the course of the projected period 70 and to determine the projected statuses 130 of the equipment 2 in the course of the following projected period 710. FIGS. 12 and 13 indeed illustrate the construction of the input arguments of the model 16 in both cases. In particular, the step-by-step simulation of the projected statuses 130 on the day before each projected maintenance 7 is due to the fact that the simulations of the projected statuses 130 for the following projected period 710 after the maintenance of rank j+1 (as can be seen in FIG. 13) integrate the maintenance decision that the simulations have made it possible to identify as sufficient in respect of the maintenance of rank j (as can be seen in FIG. 12). Similarly, the invention determines, step by step, the successive projected statuses 130 of the equipment 2 in the course of the two projected periods 70, 710. For this reason, two maintenance decisions, in respect of the maintenance 6 to be performed (maintenance of rank j) and in respect of the projected maintenance 7 (maintenance of rank j+1), respectively, and two usage scenarios 8, 81 for each of said projected periods 70, 710, are considered. In this respect, FIG. 14 shows an example of two curves of the projected status 130 of the equipment 2 such as a pump (reduced in this example to its “flow rate Q” material indicator 120).

The model 16 makes it possible to predict the projected status 130 of the pump, for the various instants of the projected period 70 (from the maintenance of rank j to the maintenance of rank j+1) and then for the various instants of the following projected period 710 (from the maintenance of rank j+1 to the maintenance of rank j+2). In particular, the simulation of the model 16 highlights that it will be necessary to work on the pump during the maintenance of rank j+1 in order to benefit from the intended zero failures (failing that, the pump would suffer a failure before the maintenance of rank j+2, as can be seen by the dotted prolongation of the curve).

FIG. 14 especially highlights a disconnection in the flow rate on either side of the maintenance of rank j+1, due to a maintenance decision performed on the pump (on the date of said maintenance of rank j+1). This maintenance decision of rank j+1 is additionally sufficient since it allows a sufficient flow rate up to the day before the maintenance of rank j+2. Similarly and more generally, the invention determines step by step the successive projected statuses 130 of the equipment 2 as they will be in the course of as many successive projected periods 70, 710 as are intended to be considered in the life of the equipment 2. For this reason a series of maintenance decisions are considered, respectively, in respect of the maintenance 6 to be performed (maintenance of rank j), and then in respect of the various projected maintenance operations 7, 71 preceding the projected periods 70, 710 in question (maintenance of rank j+1 to j+k), and a series of usage scenarios 8, 81 are considered for each of the projected periods 70, 710 in question. In this respect, FIG. 15 shows an example of two overall curves of the projected status 130 of the equipment 2 such as a pump (reduced in this example to its “flow rate Q” material indicator 120).

The model 16 makes it possible to predict the projected status 130 of the pump for the various instants of the period between the maintenance of rank j and the maintenance of rank j+k and for the various instants of the period between the maintenance of rank j+k and the maintenance of rank j+n. These curves result from the prediction, by virtue of the simulation of the model 16, of the successive projected statuses 130 of the pump for each period of operation between two successive maintenance operations (intervals delimited by the vertical dotted lines in FIG. 15).

Thus, it is highlighted that it will be necessary to work on the pump during the maintenance of rank j+k in order to benefit from the intended zero failures during each period of operation between the maintenance of rank j and the maintenance of rank j+n. Similarly, FIG. 15 especially highlights a disconnection in the flow rate on either side of the maintenance of rank j+k, due to a maintenance decision performed on the pump (on the date of said maintenance of rank j+k).

The invention thus makes it possible to determine the projected status 130 of the equipment 2 as it will be at any instant in the course of any following projected period 710 in the life of the equipment 2 (in the context of a given following scenario 81 and taking into account a maintenance decision determined as being sufficient for the projected maintenance 7).

By virtue of this prediction capability, and similarly to before, the invention makes it possible to identify, for each following projected period 710 in the life of the equipment 2, the limits to which the usage of the equipment can be pushed without compromising the intended zero failures or in which the initially envisaged usage should be restricted in order to benefit from zero failures.

Indeed, for each following projected period 710 in the life of the equipment 2 (after a given following scenario 81 and taking into account a maintenance decision determined as being sufficient for the corresponding service maintenance 7), the invention:
determines, similarly to before, the maximal limits 18 of the controllable projected usage conditions 110;
thus bounds the limit usage compatible with zero failures in the following scenario 81 in the course of said following projected period 710 and does so up to the day before the following projected maintenance 71;
these maximal limits 18 of the projected usage conditions 110 thus having been calculated, quantifies, similarly to before and preferentially, the suitability of said sufficient maintenance decision (concerning the tasks 90 for said projected maintenance 7) to the following scenario 81, by means of the margin of usage before failure (MUBF) or by means of the deviation 182 between the target value of the following scenario 81 and the maximal limit 18 for at least one controllable projected usage condition 110 of said following scenario 81;
constructs, similarly to before, the chart indicating the set of limit scenarios valid for said following projected period 710. Thus, the simulation by the model 16 makes it possible to determine, by recurrence, step by step, the series of sufficient maintenance decisions for any projected maintenance 7, and does so up to the intended projected maintenance 7 rank. In addition, for each of the following projected periods 710, the simulation allowed by the model 16 makes it possible to determine, for each of said sufficient maintenance decisions, the maximal limits 18 for each controllable projected usage condition 110 of the corresponding scenario 81, the limit polygon 181, margin of usage before failure (MUBF), the chart of limit scenarios.

According to one embodiment, said optimal decision is selected from at least said sufficient decision for the corresponding maintenance. In other words, for each projected maintenance step 7 in the life of the equipment 2, the optimal maintenance decision is selected among the maintenance decisions having been determined as being sufficient, similarly to before for the maintenance 6 to be performed. Said optimal decision is selected, preferentially with regard to the margin of usage before failure (MUBF) allowed by each sufficient maintenance decision considered, or with respect to at least one deviation 182 between the target value of the scenario 8 and the value of the maximal limit 18 for at least one of the projected usage conditions 110 of said scenario 8.

Thus, the invention foresees optimizing each of the projected maintenance operations 7 in the life of the equipment 2, by determining the optimal maintenance decision, for each maintenance step in the life of the equipment 2 and taking into account successive scenarios 8 in the life of the equipment. This decision regarding the nature of the tasks 90 for the projected maintenance 7 is customized to the complete log of the equipment, suited to the scenario 8 to allow zero failures up to the end of the projected period 70, and allows the margin of usage before failure (MUBF) intended by the operator. In other words, the invention determines by recurrence the series of optimal maintenance decisions for each of the projected maintenance operations 7 in the remainder of the life of the equipment 2. Furthermore, and for each of the projected periods 70 in the life of the equipment 2, the invention determines the maximal limits 18 (for each controllable projected usage condition 110 of the corresponding scenario 8), the limit polygon 181, the margin of usage before failure (MUBF), the chart of limit scenarios, and does so taking into account the maintenance decisions identified as optimal. For each of the projected periods 70 in the life of the equipment 2, the invention thus makes it possible to identify the limits to which the usage of the equipment can be pushed without compromising the zero failures or to which the initially envisaged usage should be restricted in order to benefit from zero failures. In other words, the invention determines by recurrence the series of limit usages of the equipment 2 for each of the projected periods 70 in the remainder of the life of said equipment 2.

As seen previously, for the maintenance 6 to be performed, the model 16 makes it possible to discriminate between sufficient maintenance decision and insufficient maintenance decision. In the case of a sufficient maintenance decision, the maintenance decision is suited to the usage scenario 8 in that it is sufficient for allowing zero failures up to the end of the projected period 70. In the case of a maintenance decision determined as insufficient, the operation of the equipment 2 in the context of the usage scenario 8 leads to a failure of the equipment 2 before the end of the projected period 70. In the latter case, the calculation of the failure date 19 is then justified. Thus, according to one embodiment, when a maintenance decision is insufficient with a projected status 130 (in the course of the projected period 70) that is less than said minimal status 17, then the failure date 19 is determined for said insufficient maintenance decision.

The failure date 19 corresponds to the instant at which the projected status 130 is equivalent to the minimal status 17. The simulation by the model 16 makes it possible to determine this failure date 19. To do this, and for a given insufficient maintenance decision concerning the maintenance 6 to be performed, for the projected period 70 and its scenario 8, the following procedure is performed. A given instant is considered in the course of the projected period 70 and the partial scenario 80 of the scenario 8 and corresponding to said instant. The model 16 is used as simulator customized to the equipment 2, by adapting the arguments submitted as input to the model 16, namely:
the manufacturing and maintenance log 9 of the equipment 2;
the insufficient maintenance decision considered in respect of the maintenance 6 to be performed;
the usage log 11 of the equipment 2;
the usage of the equipment 2 foreseen in the context of the partial scenario 80 defined up to the considered instant of the projected period 70. The model 16 is then used to solve, with respect to said instant, the equation in which the projected status 130 of the equipment 2 at said instant corresponds to the minimal status 17. For the insufficient maintenance decision considered and for the scenario 8, the failure date 19 is determined as being the solution of said equation.

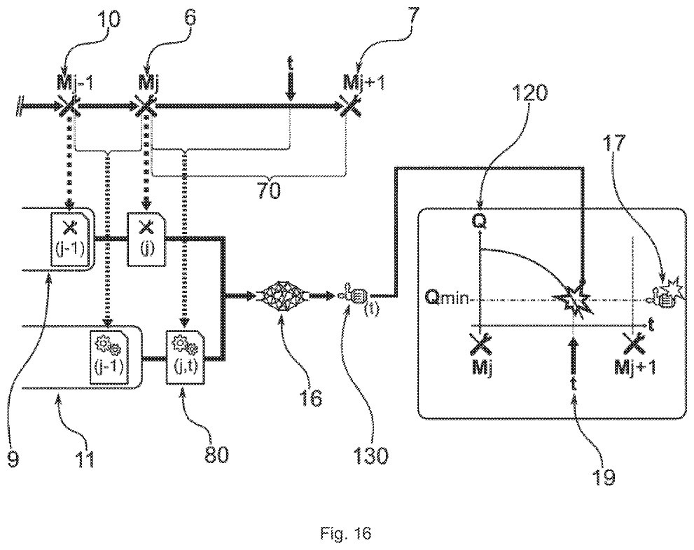

For an insufficient maintenance decision, envisaged in respect of the maintenance 6 to be performed, the failure date 19 of the equipment 2 is thus determined. The same procedure can be applied to determine, in the course of the following projected period 710, the failure date 19, associated with an insufficient maintenance decision in respect of projected maintenance 7 and associated with the following scenario 81. FIG. 16 considers the item of equipment 2 such as a pump, associated with its logs 9 and 11, a scenario 8 in the course of the projected period 70 (comprised between the maintenance 6 to be performed (of rank j) and the next projected maintenance 7 (of rank j+1)), a partial scenario 80 of the scenario 8 and associated with an instant, as well as an insufficient maintenance decision considered in respect of the maintenance 6 to be performed. FIG. 16 shows the curve of the projected status 130 of the pump (reduced in this example to its “flow rate Q” material indicator 120) that the model 16 makes it possible to predict for the various instants of the projected period 70.

The curve of the projected status 130 over time is decreasing due to aging, until reaching a projected status 130 equivalent to the minimal status 17 before the projected maintenance 7 date. In the case illustrated, the possible maintenance decision is indeed an insufficient decision: it does not allow a projected status 130 that is greater than the minimal status 17 up to the end of the projected period 70. The intercept of the curve with the minimal status 17 corresponds to the failure date 19 of the pump.

According to one embodiment, for the maintenance 6 to be performed without any maintenance decision identified as sufficient, and for at least one given insufficient decision of said maintenance 6 to be performed, the date of the end of the service life of the equipment 2 is determined as being said failure date 19 associated with said maintenance decision. In other words, in the case where, for maintenance 6 to be performed, all possible maintenance decisions prove to be insufficient (in order to allow zero failures in the course of and up to the end of the projected period 70, in the context of the scenario 8), the equipment 2 is then at the end of its life and the maintenance 6 to be performed corresponds to the last maintenance in the life of the equipment 2. When the maintenance 6 to be performed is thus identified as last maintenance in the life of the equipment 2 and for a given maintenance decision, then the date of the end of the service life of the equipment 2 is then determined as being the failure date 19 associated with said maintenance decision.

When a projected maintenance operation 7 is identified as last maintenance in the life of the equipment 2, the same procedure is applied to determine the date of the end of the service life of the equipment 2 associated with a given maintenance decision and with the following scenario 81.

According to one embodiment and for the maintenance 6 to be performed (or for the projected maintenance 7) identified as last maintenance in the life of the equipment 2, the maintenance decisions that optimize any combination among said failure date 19, a margin of last usage (MLU) and the constraints of the tasks 90 of said last maintenance decision are selected among the possible maintenance decisions.

In other words, for the maintenance 6 to be performed, identified as last maintenance in the life of the equipment 2, all the possible maintenance decisions are considered. For each of said maintenance decisions, the minimal operating duration (D_{MIN}) intended for the equipment 2 in the course of the projected period 70 are considered, namely the minimal operating duration determined as a function of the constraints of the tasks 90 relating to said maintenance decision (i.e., as a function of the nature and the volume of said tasks 90).

For example, the case of an item of equipment 2 such as a truck engine is considered, for which five possible maintenance decisions have been identified in respect of the last maintenance in the life of the equipment 2 and for each of which the intended minimal operating duration (D_{MIN}) was determined, namely:
the decision E1, which replaces the diesel filter (with an intended minimal operating duration D_{MIN} equal to 3 days);
the decision E2, which replaces injectors and diesel filter (with an intended minimal operating duration D_{MIN} equal to 1.1 months);
the decision E3, which replaces injection pump and injectors (with an intended minimal operating duration D_{MIN} equal to 2 months);
the decision E4, which replaces the injection pump, the injectors and the diesel filter (with an intended minimal operating duration D_{MIN} equal to 2.1 months);
the decision E5, which replaces the injection pump, the injectors, the diesel filter and the segmentation of the cylinders (with an intended minimal operating duration D_{MIN} equal to 12 months). Among the possible maintenance decisions, each decision is then selected according to whether the service life extension (SLE) associated with said maintenance decision (i.e., the duration between said last maintenance in the life of the equipment 2 and the date of the end of the service life of the equipment 2) is compatible with the intended minimal operating duration (D_{MIN}) taking into account said maintenance decision (i.e., SLE>D_{MIN}).

For example, the aforementioned case of the truck engine is considered with its five possible maintenance decisions identified in respect of the last maintenance to be performed in the life of the engine, for each of which the intended minimal operating duration (D_{MIN}) as well as the service life extension (SLE) have been determined, namely:
the decision E1, which replaces the diesel filter (with an intended minimal operating duration D_{MIN} of 3 days and an extension SLE of 1 month, the injectors then being the limiting factor);
the decision E2, which replaces injectors and diesel filter (with an intended minimal operating duration D_{MIN} of 1.1 months and an extension SLE of 1.5 months, the injection pump then being the limiting factor);
the decision E3, which replaces injection pump and injectors (with an intended minimal operating duration D_{MIN} of 2 months and a life extension SLE of 0.5 months, the diesel filter then being the limiting factor);
the decision E4, which replaces the injection pump, the injectors and the diesel filter (with an intended minimal operating duration D_{MIN} of 2.1 months and an extension SLE of 6 months, the segmentation then being the limiting factor);
the decision E5, which replaces the injection pump, the injectors, the diesel filter and the segmentation of the cylinders (with an intended minimal operating duration D_{MIN} of 12 months and an extension SLE of 7 months, the crankshaft then being the limiting factor).

The decision E3 does not allow a service life extension SLE (0.5 months) that is compatible with the intended minimal operating duration D_{MIN} (2 months). The same applies for the decision E5. The selected decisions are therefore the decisions E1, E2 and E4, which each allow, conversely, a service life extension SLE that is greater than the intended minimal operating duration D_{MIN}. For each possible maintenance decision thus selected in respect of the last maintenance in the life of the equipment 2, the invention determines, for each controllable projected usage condition 110 of the scenario 8:
the last usage limit, defined as the maximum possible limit, compatible with zero failures in the course of and up to the end of the intended minimal operating duration D_{MIN} of the equipment 2, after said maintenance to be performed. The invention calculates this last usage limit, in a similar manner to the maximal limits 18. Said last usage limits thus bound the limit usage to be observed in the course of the projected period 70 for zero failures up to the end of the intended minimal operating duration D_{MIN} of the equipment 2;
the deviation 182, for said controllable projected usage condition 110, between the target value in the scenario 8 and the value of the last usage limit.

For each possible maintenance decision selected, the margin of last usage (MLU) is thus deduced for all the controllable projected usage conditions 110 of the scenario 8, as being the average of said deviations (i.e., in a similar manner to the calculation of the margin of usage before failure (MUBF)).

For example, the aforementioned case of the truck engine is considered, with its three possible maintenance decisions (E1, E2 and E4) selected in respect of the last maintenance in the life of the equipment and for each of which the margin of last usage (MLU) was calculated, namely:
the decision E1, which replaces the diesel filter (with a margin MLU of 3%);
the decision E2, which replaces injectors and diesel filter (with a margin MLU of 4%);
the decision E4, which replaces the injection pump, the injectors and the diesel filter (with a margin MLU of 12%). The optimal last maintenance decision is then determined, among the last maintenance decisions previously selected, as being in a non-limiting manner the last maintenance decision:
which optimizes the service life extension (SLE);
or which optimizes the margin of last usage (MLU);
or which optimizes the last maintenance efficiency (LME) defined as being the difference between said service life extension SLE and said minimal operating duration D_{MIN}, said difference relating to said service life extension SLE (that is to say, LME=1−D_{MIN}/SLE);
or which optimizes any other criterion, combining, at the operator's discretion, at least two criteria among the service life extension (SLE), the margin of last usage (MLU) and the last maintenance efficiency (LME);
or else, in the absence of a maintenance decision that complies with the aforementioned criteria, the decision to replace the equipment 2 as new.

For example, the aforementioned case of the truck engine is considered, with its three possible maintenance decisions (E1, E2, E4) selected in respect of the last maintenance in the life of the equipment 2 (to allow the condition SLE>D_{MIN}), namely:
the decision E1, which replaces the diesel filter (with an extension SLE of 1 month, an efficiency LME of 90% and a margin MLU of 3%);
the decision E2, which replaces injectors and diesel filter (with an extension SLE of 1.5 months, an efficiency LME of 26% and a margin MLU of 4%);
the decision E4, which replaces the injection pump, the injectors and the diesel filter (with an extension SLE of 6 months, an efficiency LME of 65% and a margin MLU of 12%).

In addition, in the example, it is chosen to select the optimal decision for the last maintenance, according to the criterion that simultaneously optimizes the service life extension (SLE), the margin of last usage (MLU) and the last maintenance efficiency (LME).

The decisions E1 and E2 do not make any sense from the operational point of view (the service life extension SLE being only 1 and 1.5 months). Furthermore, these decisions offer excessively low usage confidence before failure (with a margin MLU of 3% and 4%). Conversely, the decision E4 makes much more sense operationally with a service life extension SLE of 6 months, an acceptable usage confidence before failure (margin MLU>10%) and a very acceptable efficiency LME (65%).

On the date of this last maintenance in the life of the engine, it is therefore rational not to replace the engine as new and to execute the last maintenance decision E4 (i.e., the one that comprises replacing the injection pump, injectors and diesel filter). The invention thus foresees instructing the service life extension of the engine. For the maintenance 6 to be performed identified as last maintenance in the life of the equipment 2, the invention thus selects, among the possible maintenance decisions, the one that optimizes any combination among said service life extension SLE (which takes into account said failure date 19), the margin of last usage (MLU) and the last maintenance efficiency LME (which takes into account the duration D_{MIN} and thus the constraints of the tasks 90 of said last maintenance). The invention thus foresees instructing the service life extension of the equipment 2 and thus determines the optimal service life of the equipment 2. It should be noted that this instruction for extending the service life of the equipment takes into account both the manufacturing and maintenance log 9 and the usage log 11 of the equipment 2, as well as the usage scenario 8 of the equipment 2 in the context of its service life extension.

The same procedure can be applied to determine the optimal decision for the last maintenance in respect of any projected maintenance 7 identified as last maintenance in the life of the equipment 2 and associated with the following scenario 81.

According to one embodiment, the invention determines the optimal decision for manufacturing 4 the equipment 2, namely the critical tasks 90 of the manufacturing process 4 that optimize the projected status 130 of the equipment 2 at the end of the projected period 70 and for a scenario 8. For this reason and for at least two dummy items of equipment of the same series of said equipment 2, associated with separate manufacturing decisions
a simulation is performed by submitting to said model 16 said at least two manufacturing decisions and at least one projected usage scenario 8;
the model 16 generates at least one projected status 130 for each of said two dummy items of equipment;
one of said at least two manufacturing decisions is selected as a function of the projected status 130 of said two dummy items of equipment;
the selected manufacturing decision is accessible to a designer/manufacturer. In other words, the invention considers the various possible manufacturing decisions 4 (i.e., the various possible combinations of critical tasks 90 for said manufacturing process 4). One dummy item of equipment of the series is associated with each combination.

For example, the case of an item of equipment 2 such as a pump is considered, for which the critical tasks 90 of the manufacturing process 4 are reduced to the following tasks 90:
“placing and choosing the pump bearing”, with two possible options for the type of bearing: types A and B;
“placing and choosing the pump impeller”, with three possible options for the type of impeller: types A, B and C.

The various possible combinations of critical tasks 90 of the manufacturing process 4 (i.e., the various possible decisions of the manufacturing process 4) are therefore the six combinations [type of bearing; type of impeller]: [A;A] [A;B] [A;C] [B;A] [B;B] [B;C]. The various dummy items of equipment are thus considered, each associated with a manufacturing decision 4 from among the various possible combinations of the manufacturing 4, assumed to have been carried out in the facility 3, assumed to have operated in the course of a first period of operation 5 (reduced to a single period of operation, that is to say, without comprising any prior maintenance 10) in the context of a usage log 11 (identical for all the dummy items of equipment considered). In addition to a maintenance decision in respect of the maintenance 6 to be performed (identical for all the dummy items of equipment considered), a scenario 8 (identical for all the dummy items of equipment considered) is considered.

For each dummy item of equipment, the invention then uses said model 16 as a simulator, customized to said dummy item of equipment, in order to determine the projected status 130 of said dummy item of equipment at the end of the projected period 70, by adapting the arguments submitted as input to the model 16, namely:
the manufacturing and maintenance log 9 (reduced to the manufacturing decision 4 that is specific to said dummy item of equipment);
the maintenance decision in respect of the maintenance 6 to be performed (common to all the dummy items of equipment considered);
the usage log 11 (common to all the dummy items of equipment considered);
the scenario 8 (common to all the dummy items of equipment considered).

Thus, for all the dummy items of equipment associated with their respective manufacturing decision 4 (and with any other parameter also taken into consideration), the projected status 130 of said dummy items of equipment is compared at the end of the projected period 70. Said projected statuses 130 having being compared, the best projected status 130 indicates the best manufacturing decision 4 (best combination of critical manufacturing 4 tasks 90).

According to one embodiment, the simulation by the model 16 determines the optimal manufacturing decision 4, namely the tasks 90 that optimize the optimal life cycle of the equipment 2 (the optimal life cycle comprising the series of optimal maintenance decisions for the maintenance 6 to be performed and for each of the projected maintenance operations 7, 71 in the life of the equipment 2, the series of limit usages (i.e., the maximal limits 18) for each of the projected periods 70, 710 in the life of the equipment 2, as well as the optimal service life of the equipment 2), and does so for a given usage profile (set of successive scenarios 8, 81 for the various projected periods 70, 710 in the life of the equipment 2). To do this, for at least two dummy items of equipment of the same series of said equipment 2, associated with two separate manufacturing decisions 4:
recurring simulations are performed in a similar manner for each of said at least two manufacturing decisions 4, to determine a series of optimal maintenance decisions, a series of maximal limits 18 as well as the optimal service life of the dummy item of equipment;
the optimal manufacturing decision 4 is chosen as a function of the results of said simulations;
the selected optimal manufacturing decision 4 is accessible to said designer/manufacturer. In other words, since the model 16 can simulate the projected status 130 of a dummy item of equipment of the same series in the same way as in the case of the real equipment 2 (as seen previously), the invention determines the optimal life cycle of said dummy item of equipment, in the same way as in the case of the real equipment 2. Preferably, as many optimal life cycle simulations as there are dummy items of equipment (i.e., as many simulations as possible manufacturing decisions 4) are thus performed. The optimal manufacturing decision 4 is then selected as a function of the results of said simulation, that is to say, as being the one that authorizes the best optimal life cycle. The system 1 thus makes it possible to determine, to the benefit of the manufacturer, the manufacturing decision 4 that optimizes the complete life cycle of the equipment 2 of the series. According to another embodiment, the model 16 also makes it possible to assess the sensitivity of the behavior of the equipment 2 (especially the projected statuses 130, the optimal life cycle) for the usage conditions 110 and to identify the optimal value for each usage condition 110: this indicates so many possible approaches for increasing the protection of the equipment against the usage conditions 110, or even for optimizing the operating point of the equipment.

According to one embodiment, the invention offers an operator overall supervision of all the equipment 2 of the series that they use, incorporated into the fleet of their facilities 3 (for example a fleet of vehicles). To do this, the system 1 is applied to a fleet of several items of equipment 2 of said series belonging to a single operator. The results obtained for each of said items of equipment 2 are combined, and said results are then accessible at least to said operator.

In other words, the system 1 delivers to a given operator and refreshes at all times the information relating to the optimal life cycle for each item of equipment 2 of their fleet, for one or more intended usage profiles (namely all of the usage scenarios 8, 81 over the short and long terms of the service life of each item of equipment 2), namely especially:
the schedule of the future optimal maintenance for each item of equipment 2 (i.e., the series of optimal maintenance decisions, in respect of the maintenance 6 to be performed and of the set of projected maintenance operations 7, 71 in the service life of each item of equipment 2);
the series of possible limit usages for each item of equipment 2 over the long term of its service life (i.e., for each projected period of operation 70, 710 in the service life of each item of equipment 2 and in the context of the scenarios 8, 81);
the optimal service life of each item of equipment 2. The system 1 then makes it possible to anticipate in a timely manner and to refresh at all times:
to the benefit of the players in the “supply chain”, the nature of the parts necessary for each of the maintenance operations to be performed in the life of each item of equipment 2 (i.e., for the maintenance 6 to be performed and all the future projected maintenance operations 7, 71 in the service life of each item of equipment 2);
to the benefit of the maintenance technician, the scheduling of industrial maintenance (nature of the tasks 90 to be performed for the maintenance 6 to be performed and all the future projected maintenance operations 7, 71 in the service life of each item of equipment 2);
to the benefit of the operator, all of the constraints (including the total cost) of the future maintenance operations in the life of each item of equipment 2 (for the maintenance 6 to be performed and for all the future projected maintenance operations 7, 71 in the service life of each item of equipment 2);
to the benefit of the operator, the scheduling of the possible future usage of each item of equipment 2, over the long term of its service life, and this with regard to the previously determined limit usages. Thus, the system 1 makes it possible in particular:
to evaluate and refresh at all times, during the life of each item of equipment 2, the residual value of the equipment 2;
to determine the objective price of the asset that each item of equipment 2 constitutes, and thus to appropriately inform the decision to keep or resell the equipment 2. The example of a fleet of items of equipment 2 such as trucks is considered. The system 1 makes it possible to answer the following questions for the operator of said fleet of trucks.
What is the maximal possible usage of several new trucks by the operator, between two successive maintenance operations, for different operating profiles (for example, in terms of load to be transported, mileage to be traveled, average speed, average gradient of the routes used, ambient air temperature), associated with different geographical regions (for example, such as Russia, Senegal, France)?
The operator has several trucks that have reached half of their service life and which they intend to get rid of. Taking into account their respective logs 9 and 11, taking into account their operating profile specific to the region of the world in which they are operated, what is the remaining potential of each truck (in terms of load to be transported, mileage to be traveled, average speed, service life) and which is the total cost of the projected maintenance 7 for the rest of their service life? What price can the operator ask for each truck?
The operator owns several trucks that have been operated up to now in Senegal, and are approaching the end of their service life. Taking into account the standard usage profile specific to Senegal and the specific profile in France, taking into account their respective usage and maintenance log, it is better to continue operating the trucks in Senegal or to repatriate them to France?
For each truck in the operated fleet, when does it cease to be profitable to use the truck in question, taking into account its logs 9 and 11, taking into account its optimal end-of-life date, taking into account the maximal possible usage up to the end of the service life and taking into account the total cost of future maintenance?

The invention makes it possible to refresh at the intended periodicity, or even in real time, the information of the optimal life cycle specific to each truck of the fleet in order to answer these questions: the invention thus allows optimized decisions with correct timing, in terms of management of the assets that these trucks represent. The system 1 therefore makes it possible to refresh at all times, or even in real time, and with the intended periodicity, the information of the optimal life cycle of each item of equipment 2 of the operator's fleet: this allows optimized and well-anticipated decisions, to the benefit of the operator and the maintenance technician.

The invention makes it possible to significantly improve control of design, manufacturing, maintenance and usage of the equipment 2 of a given series, with long-term visibility of the service life of each item of equipment 2. The invention therefore allows the following gains in terms of control, safety and usage confidence and economic gains, to the benefit of the designer, the manufacturer, the maintenance technician and the operators.

The invention unlocks access to the control of optimal operating and maintenance decisions for a given item of equipment 2, when these decisions involve the short term (i.e., they relate to the maintenance 6 to be performed and the usage in the course of the projected period 70).

On the one hand, the invention makes it possible to determine the optimal maintenance decision for the maintenance 6 to be performed: this decision is customized to the complete log of the equipment 2 (manufacturing and maintenance log 9 and usage log 11), is adapted to the intended usage of the equipment 2 (scenario 8) after said maintenance to allow zero failures up to the date of the next projected maintenance 7, while pushing back, as far as intended, the usage limits compatible with the intended zero failures over the projected period 70.

On the other hand, the invention does away with failure uncertainty in a controlled manner. During operation, the invention indeed provides the operator with information, refreshed in real time, of the limit usage, compatible with zero failures up to the next maintenance: the operator then knows the limits to which they can push the usage of the equipment 2 without compromising the intended zero failures, or to which they must restrict the usage in order to benefit from the intended zero failures. The invention thus unlocks access to safety and usage confidence of the equipment 2 and of the facility 3.

Indeed, by doing away with failure uncertainty during operation and in a controlled manner, the invention is a paradigm shift. It is no longer necessary for the operator to know whether they will suffer the failure or whether their failure prediction is correct. It is now the operator who decides not only on the date of the failure (for example on the date of the next projected maintenance 7), but also on the margin of usage before failure (or the margin between the intended usage of the scenario 8 and the limit usage compatible with zero failures): it is now the operator who controls the usage of the item of equipment 2 to keep it compatible with the intended zero failures.

Thus, the invention provides a true response that meets the strict requirements of equipment 2 availability (or of safety of the facility 3, when the availability of the equipment 2 is a prerequisite for the safety of the facility 3). Short-term economic advantages thus result from the invention.

In the step of the maintenance 6 to be performed as well as in the course of the operation of the equipment 2 during the projected period 70, the invention does away with failure uncertainty during operation concerning the equipment 2 and does so in a controlled manner (by access to the optimal maintenance decision and then by refreshed knowledge of the limit usage compatible with zero failures).

On the one hand, the invention thus allows the full production time of the facility 3 intended by the operator. On the other hand, the invention thus allows superior reliability guarantees in terms of maintenance and operation: the invention therefore makes it possible to further optimize the insurance contracts of the maintenance technicians and operators. The invention also unlocks access to control of operating and maintenance decisions that involve the long term.

Indeed, in terms of the long-term usage of the equipment 2, the invention makes it possible to determine, in a timely manner and at all times, the potential of the equipment 2, anticipating the usages that may be made of said equipment 2 over the long term of the remainder of its service life (by virtue of the refreshed information of the limit usages of the equipment 2 and of its optimal service life).

In terms of maintenance over the long term of the equipment 2, the invention also makes it possible to anticipate, in a timely manner and at all times, and over the long term of the service life of the equipment 2 (and for each possible usage profile of the equipment): the industrial tasks for the various future maintenance operations, the total cost of the future maintenance, the required and sufficient stock of spare parts (and thus reduces, for the supply chains, the responsiveness constraint faced with the unforeseen need for spare parts).

In addition, since the invention makes it possible, at all times in the life of the equipment 2, to evaluate and refresh the maximum remaining potential as the total cost of the projected maintenance 7 remaining in the life of the equipment 2, the invention also makes it possible to determine, at all times in the life of the equipment 2, the residual value of the equipment, as well as to inform in a relevant manner the decision to keep or resell the equipment.

Refreshing the optimal life cycle information for an item of equipment 2 or a fleet of equipment with the intended periodicity, or even in real time, thus allows optimized decisions with correct timing, in terms of management of the assets that these items of equipment represent. The invention also makes it possible to better control the design and manufacturing choices of the equipment 2 of the series, by optimizing the market strategy of the designer/manufacturer, and by allowing superior reliability guarantees in terms of design and manufacturing. This increased control is accompanied with an economic interest due to the optimization it allows of the insurance contracts of the designer/manufacturer. On the one hand, the invention makes it possible to optimize the market strategy (market positioning) of the designer/manufacturer.

For a usage profile associated with a market segment for which the equipment 2 is intended, the invention makes it possible indeed to characterize the optimal life cycle of the equipment 2, by generating associated metrics (margin between target and limit usages, optimal service life, optimal manufacturing cost and maintenance schedule over the service life). These metrics make it possible to assess the suitability of the equipment 2 for the segment in question. The invention therefore allows the designer/manufacturer to:
gain in terms of market strategy: the designer/manufacturer is therefore able to prioritize the targeting of the segments in which the equipment 2 optimizes the suitability for the segment;
gain in terms of market positioning: the designer/manufacturer is therefore able to better claim the suitability of the equipment 2 for the needs of the segment with respect to customers and competitors, metrics of the supporting model. On the other hand, the invention also allows superior reliability guarantees in terms of design and manufacturing. The invention indeed makes it possible to determine the optimal manufacturing parameters that are adapted to a given usage profile (for example adapted to a given market segment crossed with a given geographical segment). The invention also makes it possible to determine the possible approaches for optimizing the design for a given usage profile. Thus, the invention makes it possible to further optimize the insurance contracts of the designer/manufacturer. For this reason, the invention is disruptive, in particular its model 16, in view of conventional machine-learning projects, by systematizing the crossing of the functional assessment and the data and by improving the consideration of the functional assessment in the processing of the data. In doing so, the invention is disruptive, in particular with respect to the state of the art, in particular in view of predictive maintenance technologies, since it is more relevant, more powerful and offers more general applications than a simple failure prediction.

1. A digital system (1) for supervision of the operation and maintenance of at least one item of industrial equipment (2) within a facility (3), executed by at least one computing terminal, comprising at least the following steps:
installing within a facility (3) at least one item of industrial equipment (2) resulting from a manufacturing process (4) and representative of a series, then at least operating said equipment (2) in the context of a period (5) up to a maintenance step (6) to be performed;
defining at least one projected maintenance (7) subsequent to said maintenance (6) to be performed, after at least one scenario (8) with projected usage conditions (110) of said equipment (2) over a projected period (70) of operation,
characterized in that
the manufacturing (4), installation, operation and maintenance of said equipment (2) induce at least:
a manufacturing and maintenance log (9) comprising:
tasks (90) for manufacturing said at least one item of equipment (2) up to said installation, optionally tasks (90) of at least one prior maintenance (10) of said equipment (2);
a usage log (11) of said equipment (2) over said period (5) between the installation and said maintenance (6) to be performed, said usage log (11) comprising usage conditions (110) of said equipment (2) during said period (5);
a log (120) of statuses (13) of said equipment (2), said log (12) of statuses comprising material indicators (120) of said equipment (2);
in that
by means of a technical analysis of said equipment (2), at least one correlation (14) is determined between at least one of said tasks (90) and/or at least one of said usage conditions (110), and at least one of the material indicators (120) of said status (13), said correlation (14) establishing at least one link between causes of aging and consequences of aging of the equipment (2);
in the correlation (14):
the tasks (90) are characterized by those identified as critical, and/or the usage conditions (110) are characterized by those to which the equipment (2) is sensitive and exposed during operation or when stopped, the tasks (90) and the conditions (110) in question impacting the status (13) of said equipment (2);
the material status (13) of the equipment (2) is characterized by the indicators (120) identified as being representative of this status (13) of said equipment (2);
then, in the correlation (14), the following are determined:
measured physical quantities or functions of the measured physical quantities characterizing the usage conditions (110) to which said equipment (2) is sensitive and exposed during operation or when stopped;
measured physical quantities or functions of the measured physical quantities characterizing the material status (13) of the equipment (2) at a given instant;
and then
for the other equipment of said series, recovering and extracting data associated with these tasks (90), and data associated with the physical quantities or functions of physical quantities relating to these usage conditions (110) and to these material indicators (120), as identified in said correlation (14), so as to obtain a dataset (15);
training at least one virtual model (16), on the basis of the dataset (15);
and in that
during the maintenance (6) of said equipment (2) to be performed, values are submitted to said model (16):
of at least one of the tasks (90) of the manufacturing and maintenance log (9) and of at least one of the usage conditions (110) of the usage log (11),
and of at least one of the tasks (90) of the maintenance (6) to be performed and of said projected usage conditions (110) of the scenario (8);
said model (16) generating a projected status (130) of said equipment (2) subsequent to said maintenance (6) to be performed, said projected status (130) being compared to a minimal status (17) identified as being required for the operation of said equipment (2).

2. The supervision system (1) according to claim 1, characterized in that
at least one variation is made to at least one of the values of the tasks (90) of the maintenance (6) to be performed:
when the values are submitted to said model (16), the values of said variation are introduced;
among all the variations, at least one sufficient decision of the maintenance (6) to be performed is selected, for the projected status (130) of said equipment (2), greater than or equivalent to the minimal status (17), at the time of said projected maintenance (7).

3. The supervision system (1) according to claim 1, characterized in that
for a given maintenance decision, the value of at least one of the projected usage conditions (110) of the scenario (8) is modified;
when said values are submitted to said model (16), the values of said modification as well as the values of said maintenance decision are introduced;
a limit is calculated for at least one of said projected conditions (110) for the projected status (130) of said equipment (2) equivalent to the minimal status (17), at the time of the projected maintenance (7).

4. The supervision system (1) according to claim 2, characterized in that
when the values are submitted to said model (16), the selected values of said sufficient maintenance decision are introduced;
a maximal limit (18) of said projected condition (110) is calculated for this sufficient maintenance decision, for the projected status (130) of said equipment (2) equivalent to the minimal status (17), at the time of the projected maintenance (7).

5. The supervision system (1) according to claim 4, characterized in that
a margin of usage is determined for at least one of the projected usage conditions (110) of said scenario (8), as being the deviation (182) between the corresponding value and the corresponding maximal limit (18).

6. The supervision system (1) according to claim 5, characterized in that
an optimal decision is selected from among the sufficient decisions, as having the acceptable margin of usage or as having at least one of said acceptable deviations (182).

7. The supervision system (1) according to claim 6, characterized in that it comprises
a graphic representation in the form of a chart, with at least one curve associated with at least a first one of the projected conditions (110) as a function of a second one of said projected conditions (110),
said chart determining the maximal limit (18) of a first projected condition (110).

8. The supervision system (1) according to claim 1, characterized in that
in the correlation (14), the manufacturing and maintenance log (9) is reduced to a log of the critical tasks (90) in the form of at least one list of successive values, each of the values of the list characterizing the task (90) in question in a given maintenance operation,
in each list, only the persistent value is chosen as being the value adopted in the last maintenance operation during which the task (90) in question was performed
only the persistent values are retained in the log (9) of the critical tasks (90).

9. The supervision system (1) according to claim 1, characterized in that
in the correlation (14), the functions of the measured physical quantities of the usage conditions (110) comprise
a calculation of the time of presence of the measured physical quantities in at least one range of values;
and/or
a calculation representative of at least one fluctuation of the measured physical quantities:
and/or
a counting of said at least one fluctuation.

10. The supervision system (1) according to claim 1, characterized in that
in the correlation (14), periodically,
the recovery of new data from at least one manufacturer, maintenance technician and/or operator is repeated,
then said new data is extracted to obtain a completed dataset (15),
followed by updating the training of said model (16) on the basis of said completed dataset (15).

11. The supervision system (1) according to claim 1, characterized in that
subsequent to said maintenance (6) once it has been performed, values are submitted to said model (16)
of at least one of the tasks (90) of the manufacturing and maintenance log (9), of at least one task (90) of the maintenance (6) performed
and of at least one of the usage conditions (110) of the usage log (11) since said maintenance (6) was performed
and of said projected usage conditions (11) of the scenario (8),
said model (16) refreshing the projected status (130) of said equipment (2), said projected status (130) being compared to a minimal status (17) identified as being required for the operation of said equipment (2).

12. The supervision system (1) according to claim 5, characterized in that
at least the following steps are performed:
at least said sufficient decision of the maintenance (6) to be performed is assumed to have been performed and the scenario (8) is assumed to have been executed up to the projected maintenance (7) following said maintenance (6) to be performed;
then, at least one variation is made to at least one of the values of the tasks (90) of said projected maintenance (7);
when the values are submitted to said model (16), the values of said variation as well as the values of a following scenario (81) foreseen for the projected period (710) of operation following said projected maintenance (7) are introduced;
among all the variations, at least one sufficient decision is selected for said projected maintenance (7), for the projected status (130) of said equipment (2) greater than or equivalent to the minimal status (17), at the time of the maintenance (71) following said projected maintenance (7);
at least one of the maximal limits (18) as well as the margin of usage associated with said sufficient maintenance decision thus selected and with said following scenario (81) are determined;
then said steps are repeated in a recurrent manner for every other following projected maintenance in the life of the equipment (2).

13. The supervision system (1) according to claim 6, characterized in that
said optimal decision is selected from at least said sufficient decision for the corresponding maintenance.

14. The supervision system (1) according to claim 2, characterized in that
when a maintenance decision is insufficient with a projected status (130) that is less than said minimal status (17), the failure date (19) is determined for said corresponding maintenance decision.

15. The supervision system (1) according to claim 14, characterized in that
for the maintenance (6) to be performed or for a projected maintenance (7, 71) without any maintenance decision identified as sufficient, and for at least one given insufficient decision of said maintenance (6) to be performed, the date of the end of the service life of the equipment (2) is determined as being said failure date (19) associated with said maintenance decision.

16. The supervision system (1) according to claim 15, characterized in that
for the maintenance (5) to be performed or for a projected maintenance identified as last maintenance in the life of the equipment (2),
the maintenance decision that optimizes any combination among said failure date (19), a last margin of usage and the constraints of the tasks (90) of said last maintenance is selected among the possible maintenance decisions.

17. The supervision system (1) according to claim 1, characterized in that
for at least two dummy items of equipment of the same series of said equipment (2), associated with separate manufacturing decisions
a simulation is performed by submitting to said model (16) said at least two manufacturing decisions and at least one projected usage scenario (8) over the assumed service life of said two dummy items of equipment;
the model (16) generates at least one projected status (130) for each of said two dummy items of equipment;
one of said at least two manufacturing decisions is selected as a function of the projected status (130) of said two dummy items of equipment;
the selected manufacturing decision is accessible to a designer/manufacturer.

18. The supervision system (1) according to claim 12, characterized in that
for at least two dummy items of equipment of the same series of said equipment (2), associated with two separate manufacturing decisions;
recurring simulations are performed in a similar manner for each of said at least two manufacturing decisions, to determine the optimal life cycle associated with each of said manufacturing decisions: a series of optimal maintenance decisions, a series of maximal limits (18) and margin of usage associated with these optimal maintenance decisions as well as the associated optimal service life of the dummy item of equipment;
the optimal manufacturing decision is chosen as a function of the results of said simulations;
the selected optimal manufacturing decision is accessible to said designer/manufacturer.

19. The supervision system (1) according to claim 1, characterized in that
it is applied to a fleet of several items of equipment (2) of said series belonging to a single operator;
the results obtained are combined for each of said items of equipment (2);
said results are accessible at least to said operator.

20. The supervision system (1) according to claim 1, characterized in that
the training of said model (16) belongs to the field of artificial intelligence and can be machine learning.
